(19) United States
(12) Patent Application Publication
(10) Pub. No.: US 2021/0306378 A1
(43) Pub. Date: Sep. 30, 2021

(54) INTEGRATED BUSINESS APPLICATION PLATFORM

(71) Applicant: Onapsis Inc., Boston, MA (US)

(72) Inventors: Mariano Ñunez di Croce, Boston, MA (US); Juan Pablo Perez Etchegoyen, Boston, MA (US); Ashish Larivee, Boston, MA (US); Alexander Horan, Boston, MA (US); Paul Stamp, Boston, MA (US); Maya Tal, Boston, MA (US)

(73) Assignee: Onapsis Inc., Boston, MA (US)

(21) Appl. No.: 17/219,319

(22) Filed: Mar. 31, 2021

Related U.S. Application Data
(60) Provisional application No. 63/002,814, filed on Mar. 31, 2020.

(51) Int. Cl. H04L 29/06; G06Q 10/06

(52) U.S. Cl. CPC H04L 63/20; G06Q 10/0635

(57) ABSTRACT

A business application, such as an enterprise resource planning (“ERP”) system, may include a number of different systems. Security management of the business application may include numerous systems and products. A combination of those systems and products into an underlying platform can include a single user interface that covers multiple security functions.

### PRIORITY CLAIM

This application claims priority to Provisional patent application No. 63/002,814, filed on Mar. 31, 2020, entitled “INTEGRATED BUSINESS APPLICATION PLATFORM”, the entire disclosure is herein incorporated by reference.

### TECHNICAL FIELD OF THE INVENTION

The present invention relates to an integrated platform for business applications.

### BACKGROUND

Businesses may rely on electronic systems using database technology to manage their key processes. There may be a number of business applications that businesses rely on. One example business application is an Enterprise Resource Planning (ERP) system. Other example business applications include Customer Relationship Management (CRM), Supply Chain Management (SCM), Product Lifecycle Management (PLM), Human Capital Management (HCM), and Business Intelligence (BI). These business applications are in charge of processing sensitive business data and, accordingly, the confidentiality, integrity and availability of this information is therefore critical for the security and continuity of the business. Reducing the risk of security leaks or compliance breaches in the database system is a major concern. There may be a number of different products/systems to help with the security of the business application. However, those products and services may be very specialized and unique for focusing on single security issue.

### BRIEF SUMMARY

The present invention relates to a method, system or apparatus and/or computer program product for a central or integrated platform that unifies multiple systems of a business application. The integrated platform can combine multiple different products/systems into a single user interface. Exemplary products include those for improved functionality and security of business applications. In one example, the business application may be an enterprise resource planning (“ERP”) landscape/system. SAP® and Oracle® ERP Cloud are two examples of an ERP landscape. Other example business applications include Customer Relationship Management (CRM), Supply Chain Management (SCM), Product Lifecycle Management (PLM), Human Capital Management (HCM), and Business Intelligence (BI). The embodiments described herein relate to integrating multiple products or systems that provide different functions for a business application into a single integrated platform.

### BRIEF DESCRIPTION OF THE DRAWINGS

The figures illustrate principles of the invention according to specific embodiments. Thus, it is also possible to implement the invention in other embodiments, so that these figures are only to be construed as examples. Moreover, in the figures, like reference numerals designate corresponding modules or items throughout the different drawings.

FIG. 1 illustrates an inventory of assets.

FIG. 2 illustrates assets added to the inventory.

FIG. 3 illustrates undiscovered assets.

FIG. 4 illustrates filtering undiscovered assets.

FIG. 5 illustrates asset details.

FIG. 6 illustrates issue occurrences.

FIG. 7 illustrates a detail pane for an occurrence.

FIG. 8 illustrates occurrences for an asset.

FIG. 9 illustrates asset connections.

FIG. 10 illustrates an assess dashboard.

FIG. 11 illustrates assess issues.

FIG. 12 illustrates additional assess issues.

FIG. 13 illustrates a workflow configuration screen.

FIG. 14 illustrates assess issues overview.

FIG. 15 illustrates assess issues comparison.

FIG. 16 illustrates assets relate to a particular issue.

FIG. 17 illustrates issue management.

FIG. 18 illustrates module output.

FIG. 19 illustrates an issue's solution.

FIG. 20 illustrates a dashboard for compliance.

FIG. 21 illustrates a job specific interface.

FIG. 22 illustrates a policies list.

FIG. 23 illustrates job details from the policies list.

FIG. 24 illustrates a job overview.

FIG. 25 illustrates job executions.

FIG. 26 illustrates a job execution list.

FIG. 27 illustrates issue occurrences for a job.

FIG. 28 illustrates policy control of a job.

FIG. 29 illustrates a job issue occurrences page with results.

FIG. 30 illustrates job editing.

FIG. 31 illustrates policy editing.

FIG. 32 illustrates creating a new policy.

FIG. 33 illustrates editing policy details.

FIG. 34 illustrates viewing a module.

FIG. 35 illustrates configuring a module.

FIG. 36 illustrates adding a module.

FIG. 37 illustrates linking policies.

FIG. 38 illustrates creating custom modules.

FIG. 39 illustrates a download pane.

FIG. 40 illustrates global filters.

FIG. 41 illustrates authentication sources.

FIG. 42 illustrates a topology explorer system landscape map.

FIG. 43 illustrates a sidebar display for the topology explorer system landscape map.

FIG. 44 illustrates a notification for the topology explorer system landscape map.

FIG. 45 illustrates a redirection in a topology explorer system landscape map.

FIG. 46 illustrates an issue summary for a topology explorer system landscape map.

FIG. 47 illustrates issue occurrences in a topology explorer system landscape map.

FIG. 48 illustrates a user list for a topology explorer system landscape map.

FIG. 49 illustrates assigning a user for a topology explorer system landscape map.

FIG. 50 illustrates a commenting with an assigned user for a topology explorer system landscape map.

FIG. 51 illustrates a confirmation for issue assignment in a topology explorer system landscape map.

FIG. 52 illustrates a topology explorer system landscape map in progress.

FIG. 53 illustrates a block diagram of an example network system.

### DETAILED DESCRIPTION OF THE DRAWINGS AND PREFERRED EMBODIMENTS

By way of introduction, the disclosed embodiments relate to systems and methods for integrating multiple systems of a business application into one platform. The underlying platform provides for multiple different products/systems from a business application into a single user interface. The business application may be an enterprise resource planning (“ERP”) landscape/system. SAP® and Oracle® ERP are two examples of an ERP landscape. Other example business applications include Customer Relationship Management (CRM), Supply Chain Management (SCM), Product Lifecycle Management (PLM), Human Capital Management (HCM), and Business Intelligence (BI). The embodiments described herein relate to an underlying platform that connects multiple systems from across the business application.

Security systems or products for a business application, such as an ERP landscape may provide a variety of functions and have a variety of features. Combining each of those systems or products into a single user interface with an underlying integration can provide improved ease of use and better features for customers of the business application and the security systems/products.

One example of the security systems/products may include an assessment and compliance module that assesses problems, checks configurations, and scans the business application to identify problems. Another example of the security systems/products may include a detection and response module. The detection and response module may include real-time monitoring for detecting vulnerabilities by watching the business application. Another example of the security systems/products may include an enforce and protect module. The enforce and protect module can prevent problems from arising, such as preventing certain configuration changes to the business application. Additional security systems/products include Virtual Forge® products, such as CodeProfiler which analyzes code. The TransportProfiler analyzes transports in a business application. The Interface Profiler analyzes interfaces in a business application. The CleanUpSolutions corrects vulnerabilities in code. Each of those products can be integrated with an underlying central system for controlling multiple applications.

Each of the security systems/products can be integrated with a single underlying platform. The systems/products may also be referred to as packages or applications and include different functionality that is integrated into a single platform. The integration may be organized into different packages. Specifically, the integrated platform may include: 1) Assess=find problems; 2) Control=fix the problems by responsibly making changes; 3) Compliance=translate risks; and 4) Defense=monitor for preventing future problems. The four packages are merely exemplary and the integrated platform can be organized differently with more or fewer packages.

The assess package includes an overview of risks with a check for badness that includes code scanning, interface analysis, transport analysis, etc. to find risks across the entire system. The system can be scanned for configuration issues and may include an assessment of code that is already in production.

The control package manages the process. It may include the enforce and protect module discussed above. Code correction may be part of the fix for the control package. The fix must be responsible to avoid creating additional problems. This may include scanning code while it is in development.

The comply package translates what technically is a risk in the assess package and provides the compliance language and compliance impact. The defense package adds monitoring for all communications, interfaces, running code, etc. The defense package provides protection for future risks. The packages may have correlation between one another. The cross correlation effect can improve security.

The entire integration may be managed by an underlying platform. This platform may be referred to as the integrated business application platform and may include user management, reporting, and operational management. The integrated business application platform is shown in the following user interface.

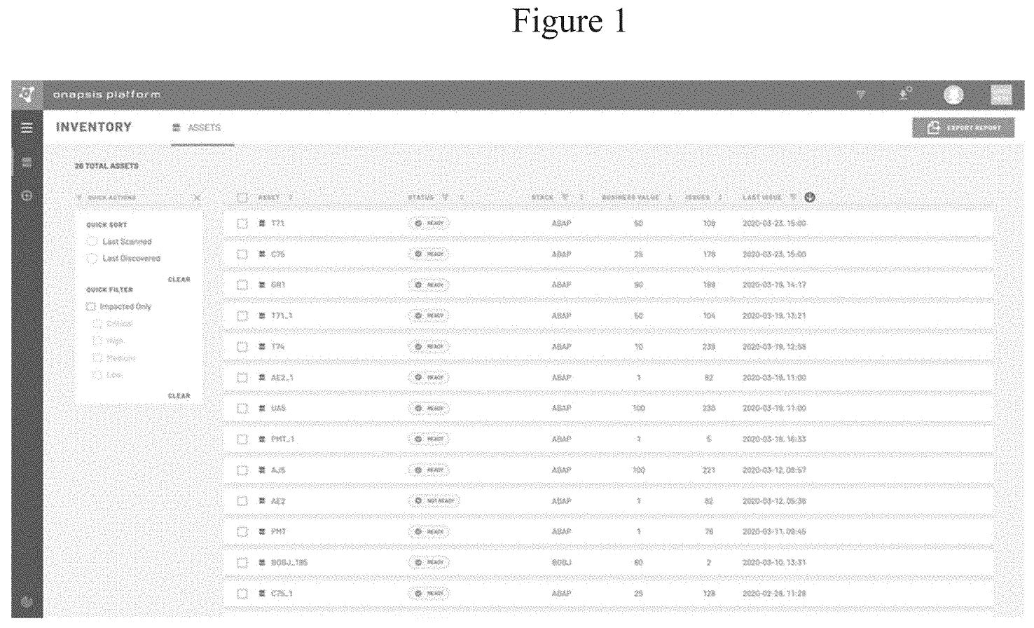

FIG. 1 illustrates an inventory of assets. The assets can be selected and added to the inventory. The assets may be features, elements, code, or systems to be analyzed for security.

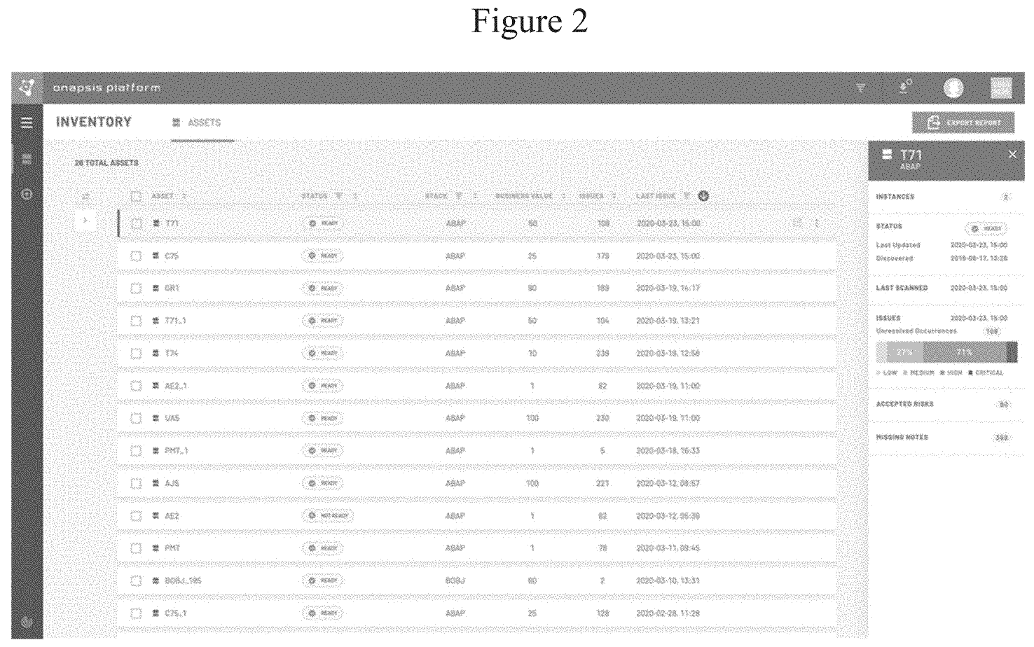

FIG. 2 illustrates assets added to the inventory. An issue row can be clicked for closing the filter panel and opening the detail panel. Clicking on the Jump-To button can lead to the asset details screen or screens.

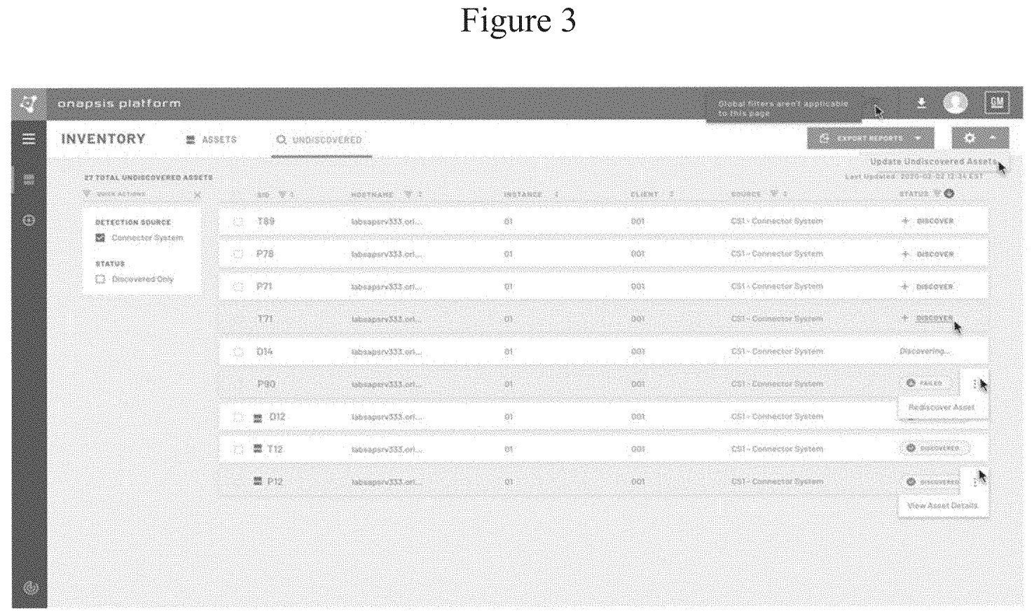

FIG. 3 illustrates undiscovered assets. Clicking on undiscovered in the inventory screen shows undiscovered assets.

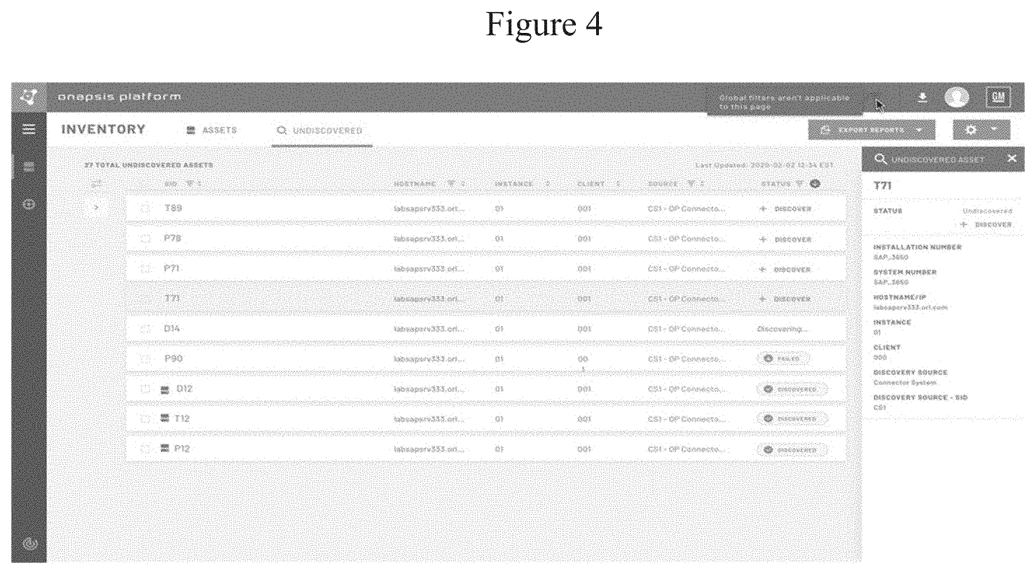

FIG. 4 illustrates filtering undiscovered assets. On the undiscovered assets page, a selection of a row closes the filter panel and the details panel opens.

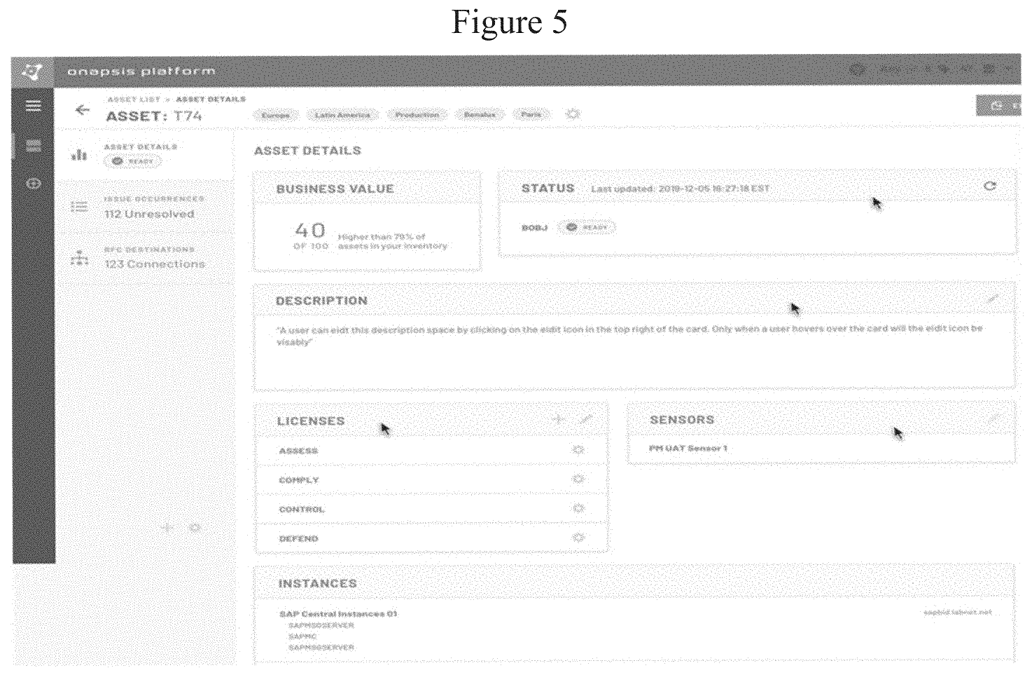

FIG. 5 illustrates asset details. The details about the asset may include business value, status or add-on status, description, applied licenses, sensor(s), instances, clients and tenants or other features that are relevant based on the asset type. The tabs on the left can navigate to other pages related to the asset.

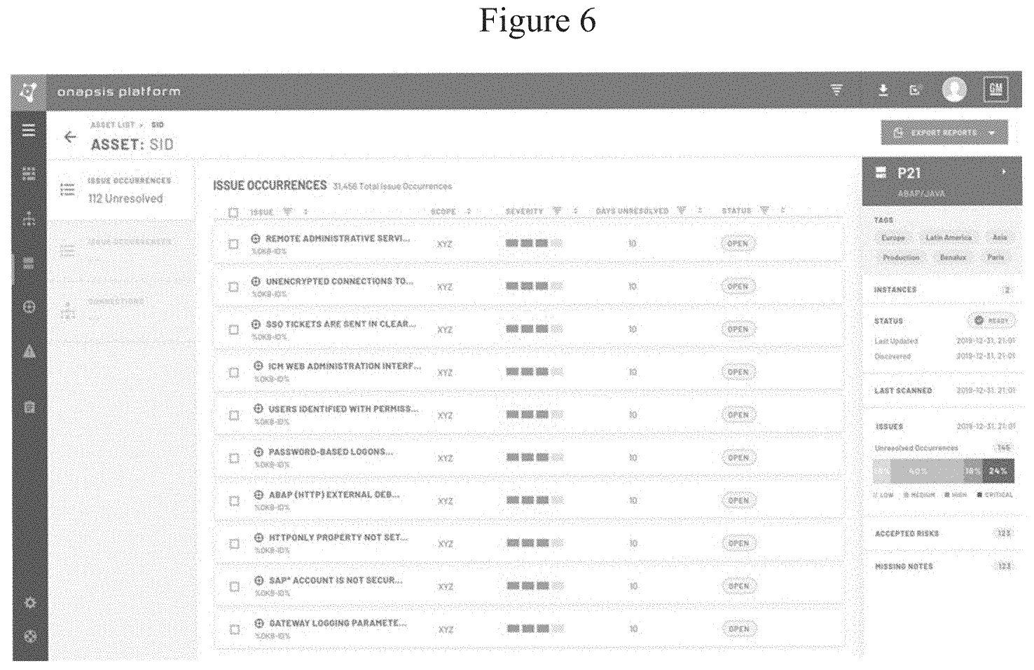

FIG. 6 illustrates issue occurrences. Issue occurrences may be security issues.

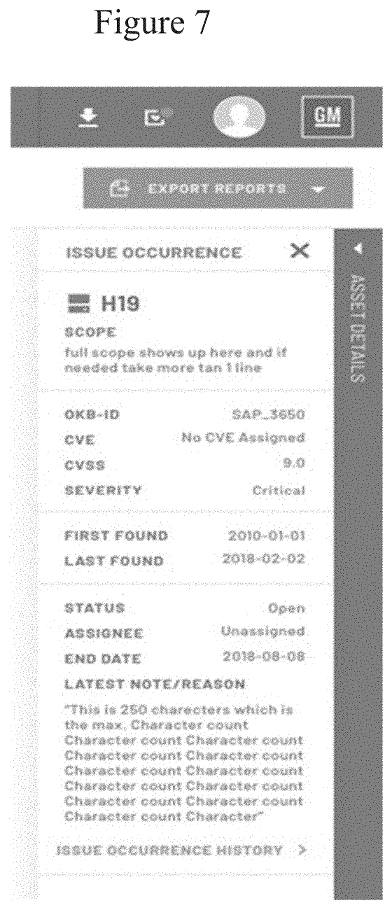

FIG. 7 illustrates a detail pane for an occurrence. The detail pane may include further information on the asset and the occurrence for that asset.

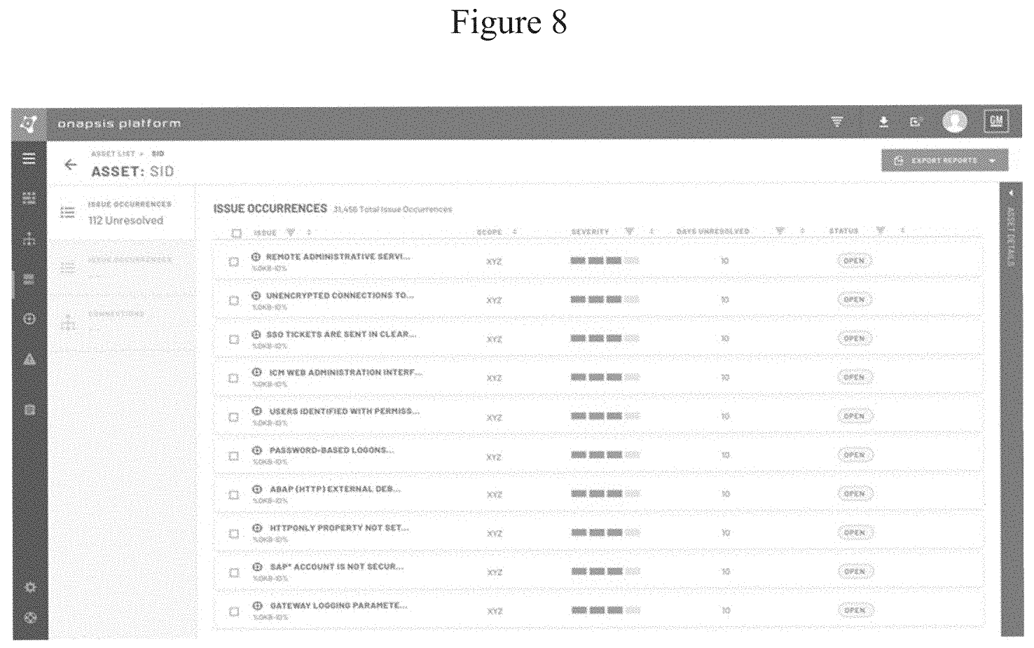

FIG. 8 illustrates occurrences for an asset. The list may be all issue occurrences for a particular asset. Clicking on an issue row changes the details panel information to show information relevant to the row selected. The details pane can be collapsed. Selecting multiple rows from the checkboxes opens a batch action bar, from which one or multiple occurrences can be managed. Clicking on the Document icon in a row displays this issue occurrence's module output. The tabs on the left allow for navigation to other pages related to the asset.

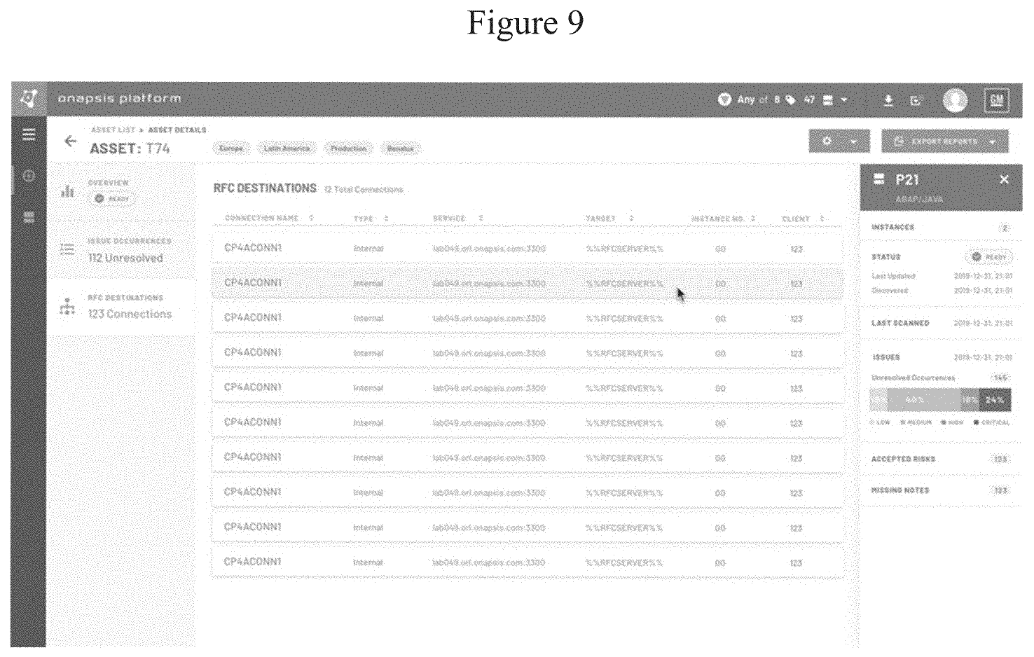

FIG. 9 illustrates asset connections. A list of connections is displayed. The tabs on the left can navigate to other pages related to this asset.

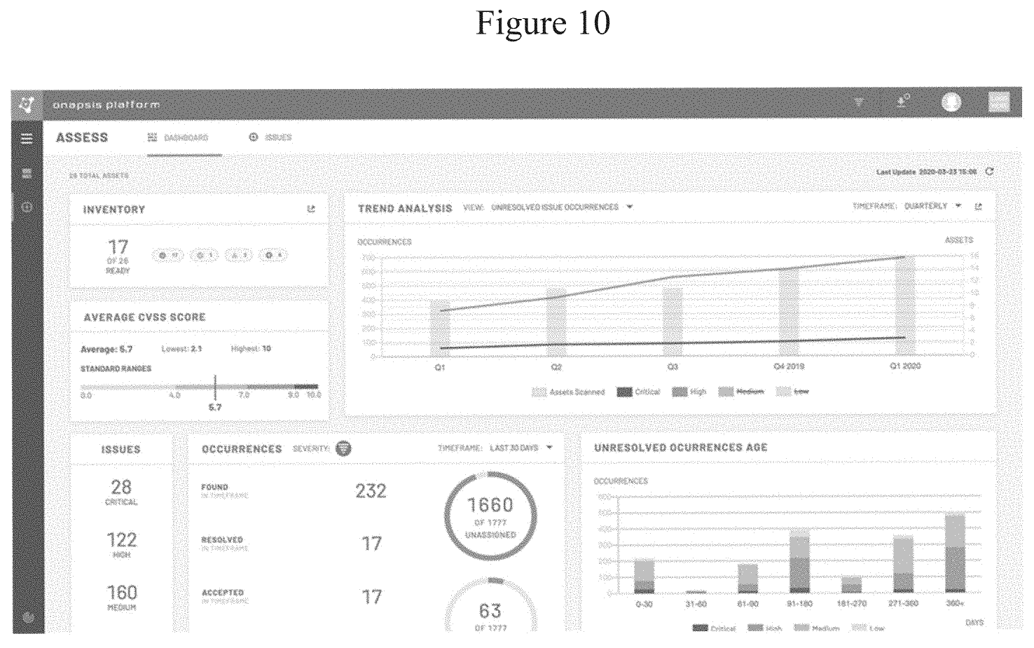

FIG. 10 illustrates an assess dashboard. The assess dashboard may be one of the options from the left tab. Different filters can change the view of the screen. The assess dashboard may be related to features for the assess package discussed above.

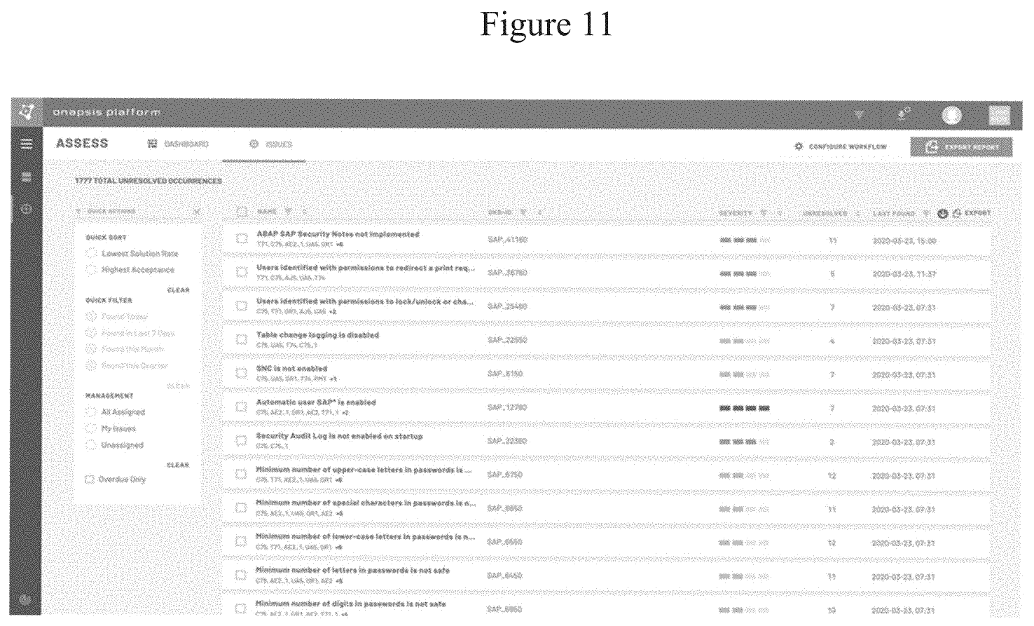

FIG. 11 illustrates assess issues. For the assess package, issues or occurrences may be security concerns that are displayed.

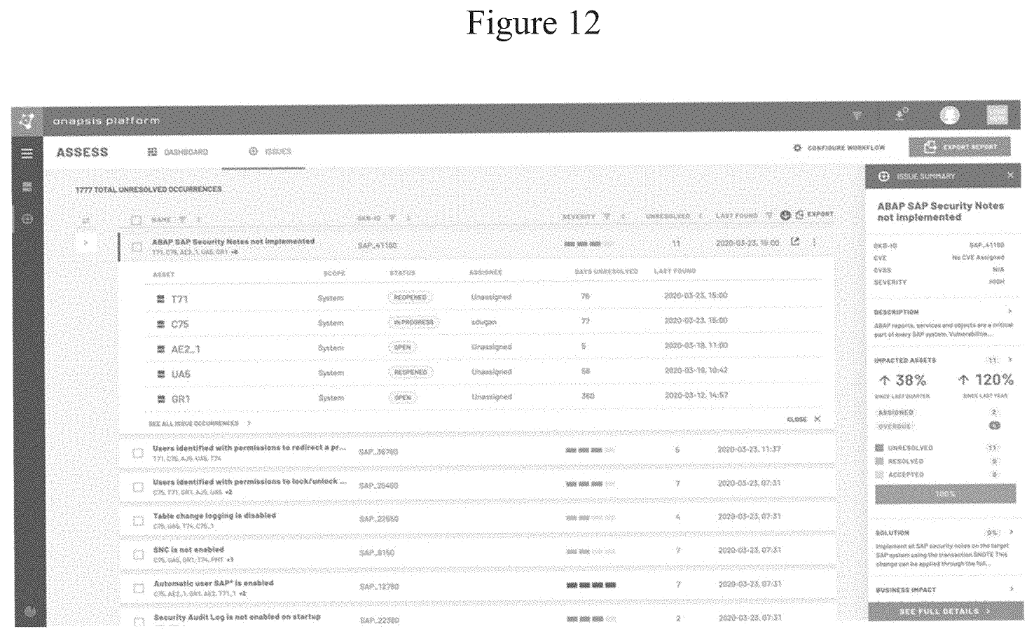

FIG. 12 illustrates additional assess issues. Clicking on the Issues tab displays the list of issues. Clicking on an issue closes the filter panel and opens the details panel and may preview the latest occurrences of this issue. Clicking on the jump to page shows this issue's overview. The ‘see full details’ button provides this issue's overview details. Clicking on “See All Issue Occurrences” shows all this issue's occurrences.

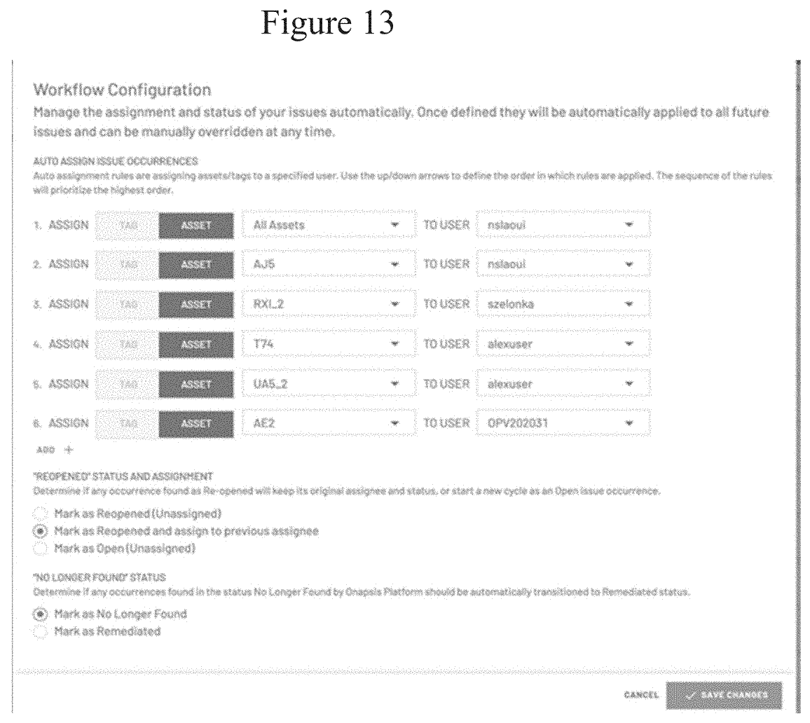

FIG. 13 illustrates a workflow configuration screen. Clicking on “Configure Workflow” shows a screen for setting automatic rules for assigning occurrences and controlling their statuses automatically.

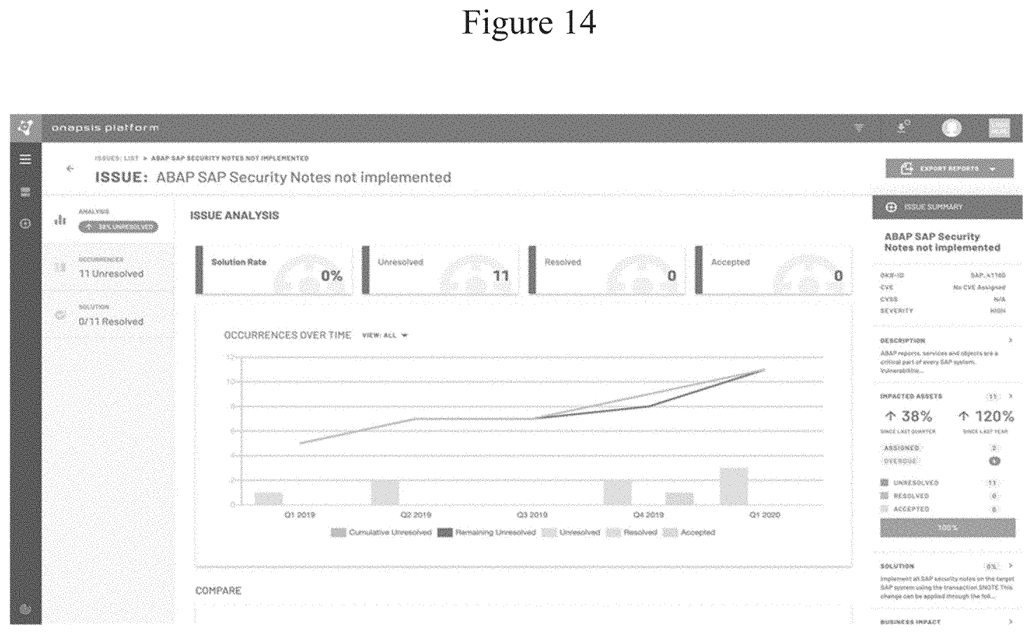

FIG. 14 illustrates assess issues overview. The overview includes a metrics cards, a graph, and a compare table. The view can show only changes in one option.

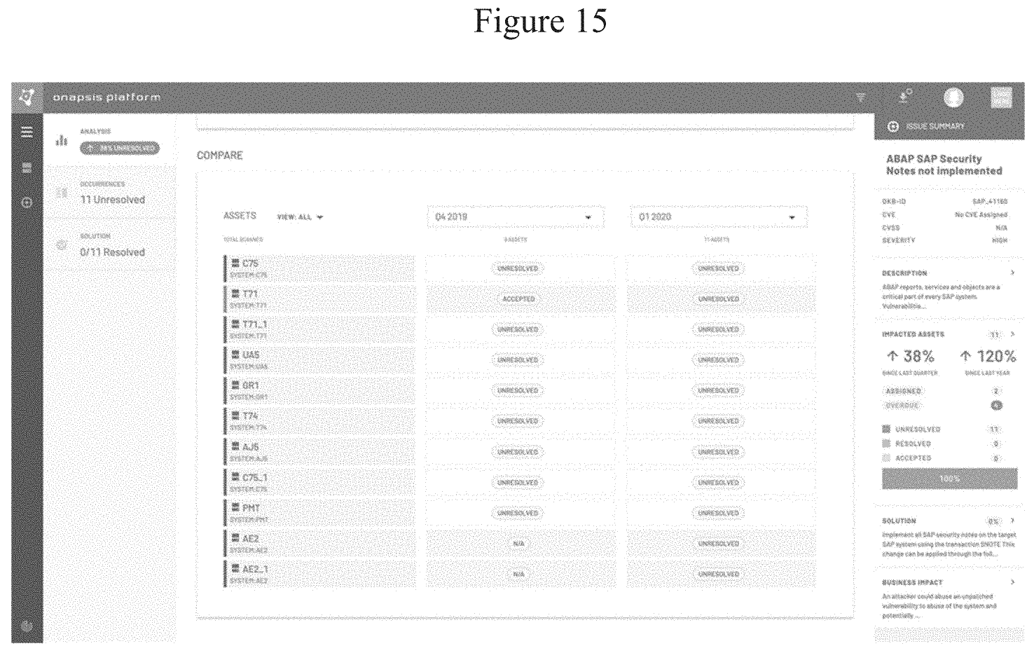

FIG. 15 illustrates assess issues comparison. Switching to the comparison view shows a comparison between two points in time. The tabs on the left can navigate to other pages related to this issue.

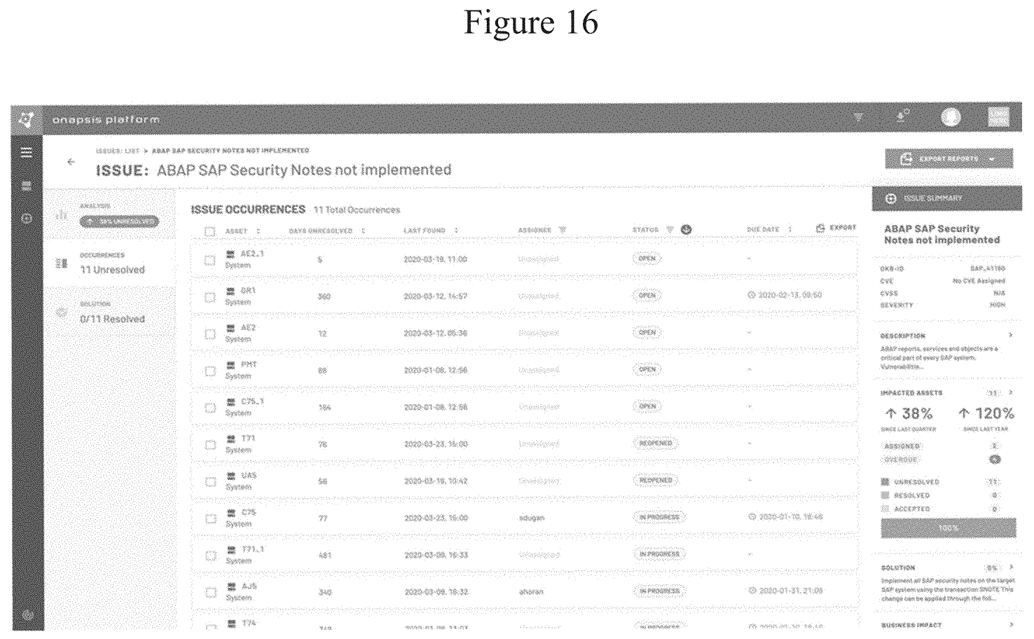

FIG. 16 illustrates assets relate to a particular issue. This view shows a list of all assets affected by the selected issue. The tabs on the left can navigate to other pages related to this issue.

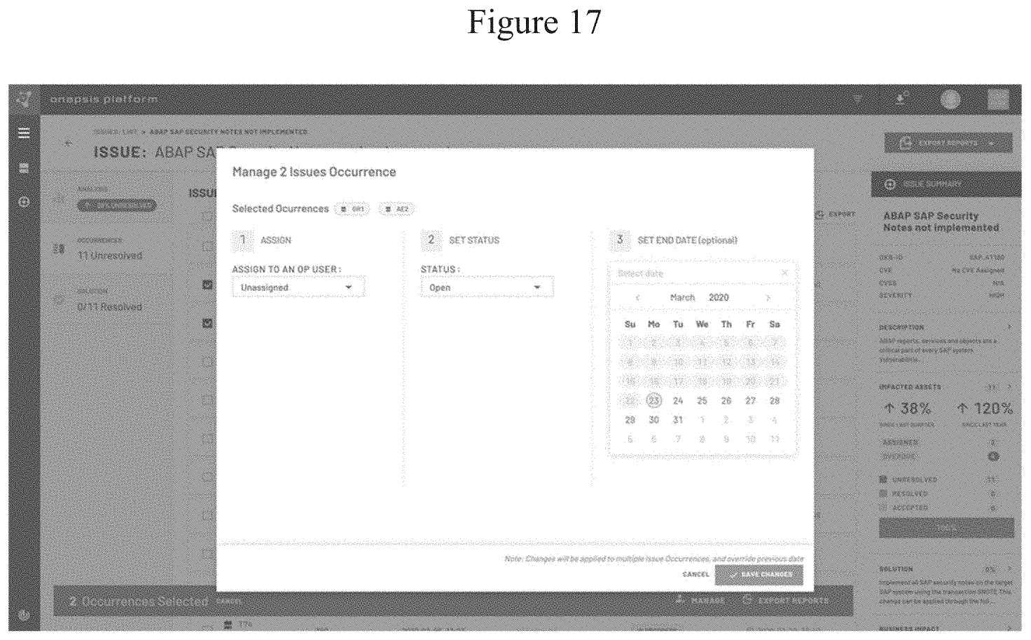

FIG. 17 illustrates issue management. Clicking on an issue row changes the details panel information to show only information relevant to the row selected. Selecting multiple rows from the checkboxes opens the batch action bar for managing one or multiple occurrences.

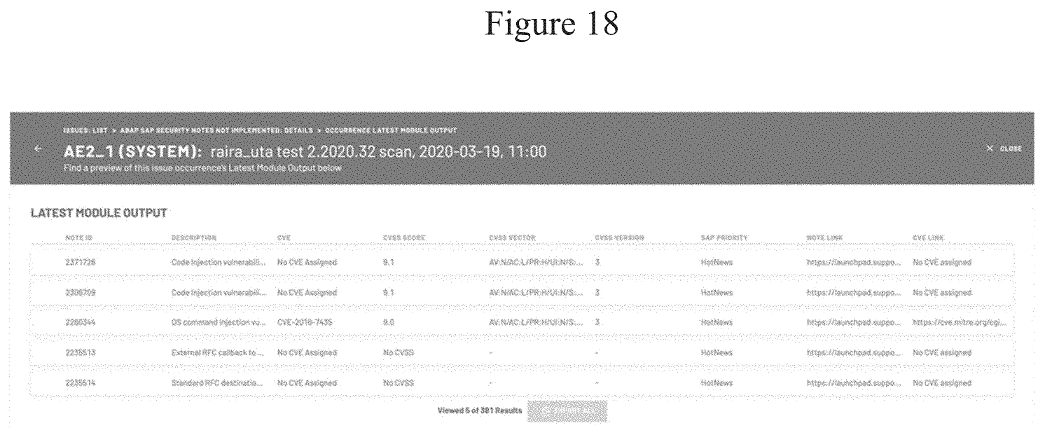

FIG. 18 illustrates module output. In FIG. 16, clicking on the Document icon in a row shows this issue occurrence's module output. The module output can export or go back to the issue occurrences list.

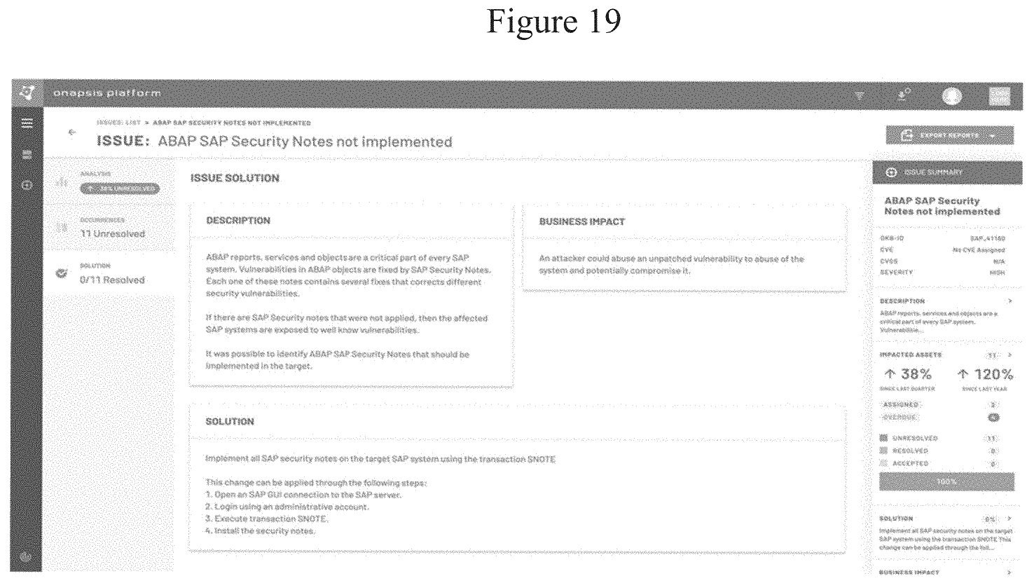

FIG. 19 illustrates an issue's solution. The solution page shows a description, business impact, the solution, and external references of the issue. The tabs on the left navigate to other pages related to this issue.

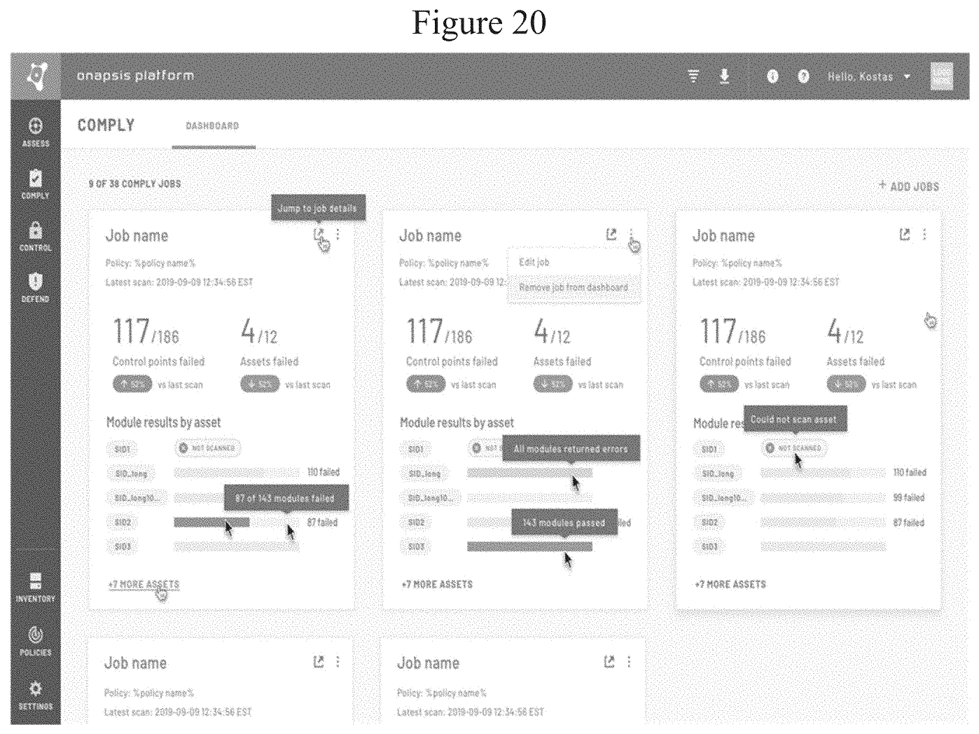

FIG. 20 illustrates a dashboard for compliance.

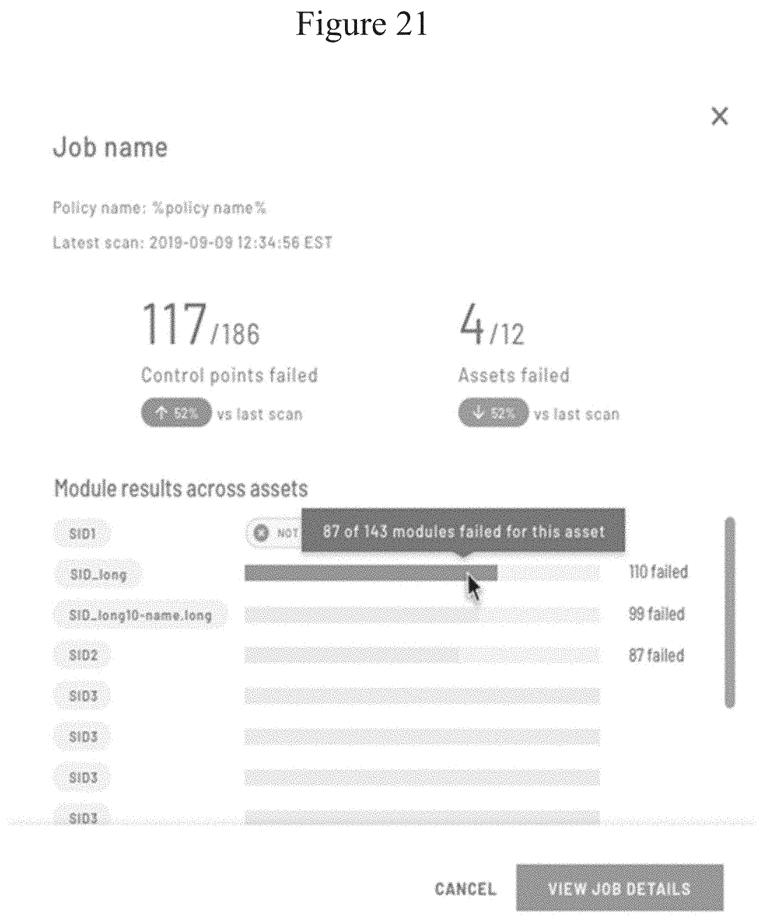

FIG. 21 illustrates a job specific interface.

Clicking on Comply on the side navigation takes me to the comply dashboard. Here I can see preview cards for my selected compliance audit jobs. In the preview card I see metrics related to the compliance of this policy across the selected assets. I can remove the cards, drag and drop the cards to reorder them, jump to the job overview page or edit the job. If I click in the card on the go to icon a modal opens and allows me to see all of the assets included in the job.

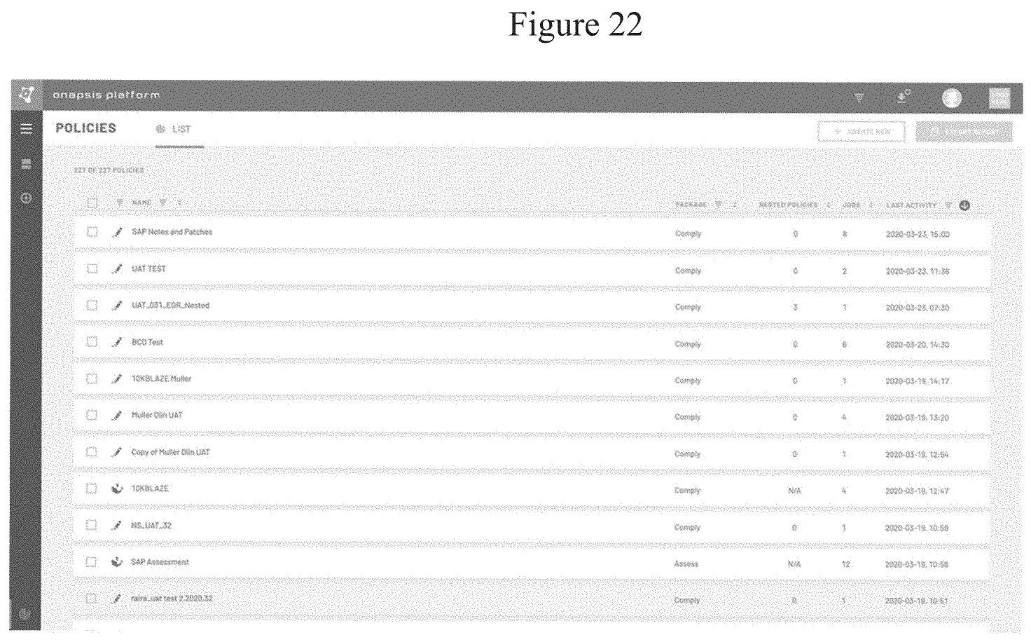

FIG. 22 illustrates a policies list. Clicking on a row's Jump To icon can show job details.

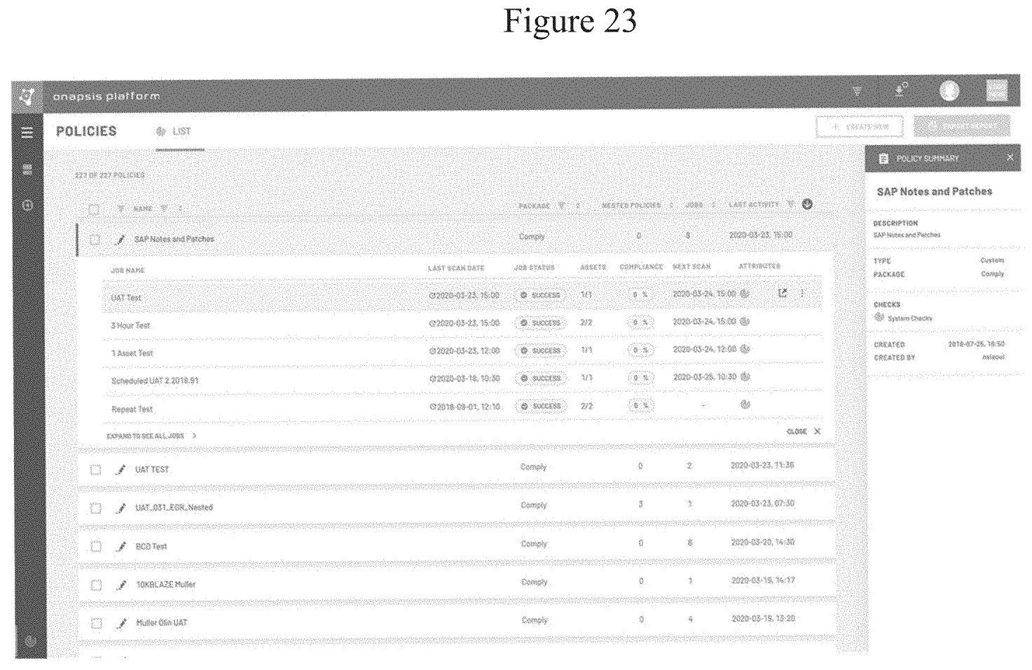

FIG. 23 illustrates job details from the policies list. Clicking on a policy shows a details panel with the policy details, and shows the latest jobs executed using this policy.

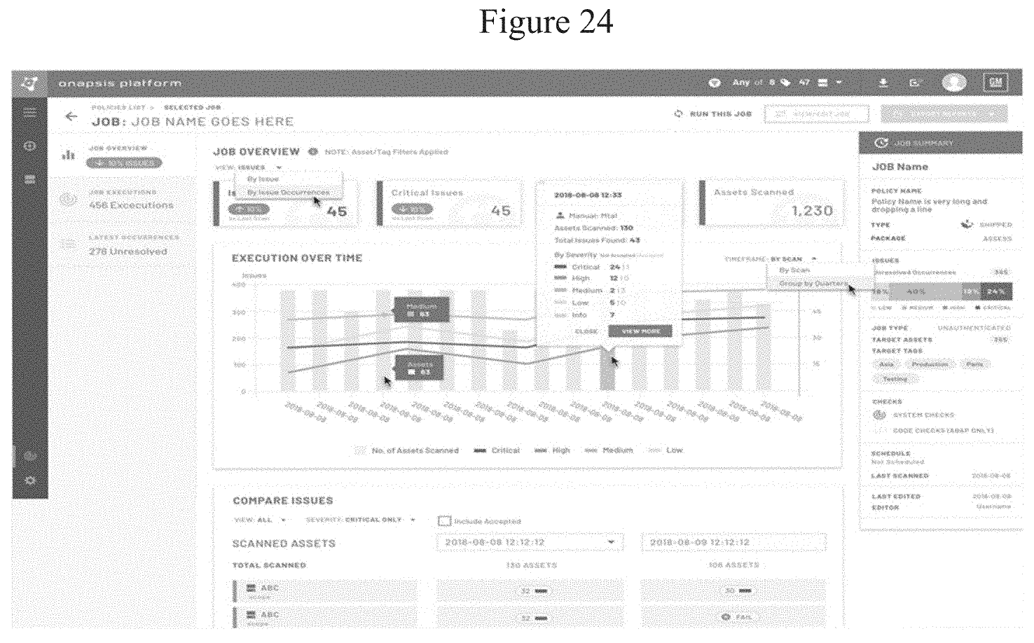

FIG. 24 illustrates a job overview. The overview includes metrics cards, a graph, and a compare table. The view can be switched to see only changes or all assets and see a comparison between two points in time. The tabs on the left can navigate to other pages related to this job.

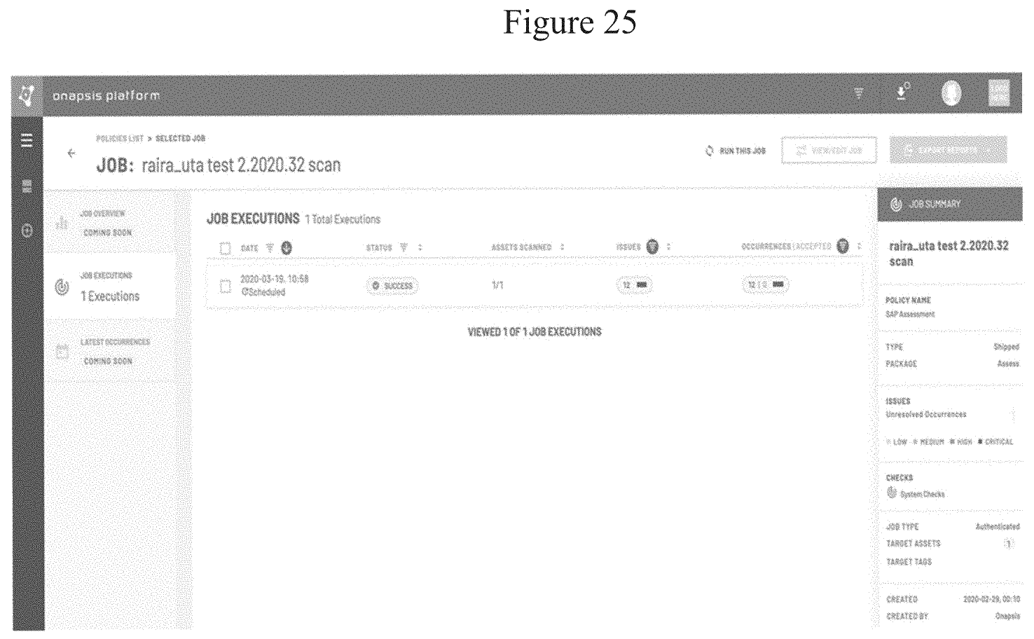

FIG. 25 illustrates job executions. The executions may be for the Asses package or the Compliance package. This may display all executions for a particular job. The tabs on the left can navigate to other pages related to this job.

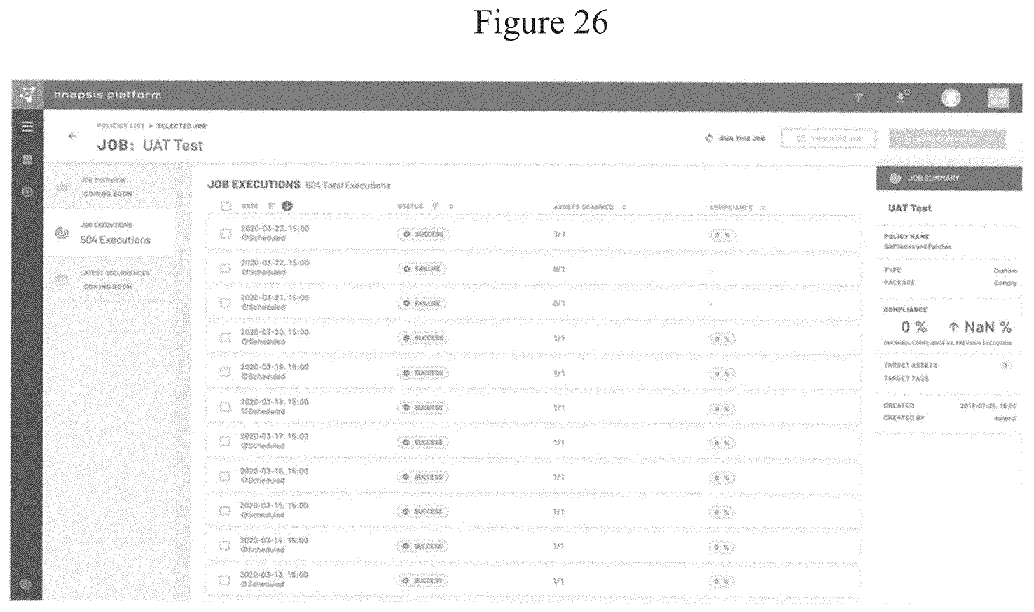

FIG. 26 illustrates a job execution list. From the issues results for that job execution can be shown for each row.

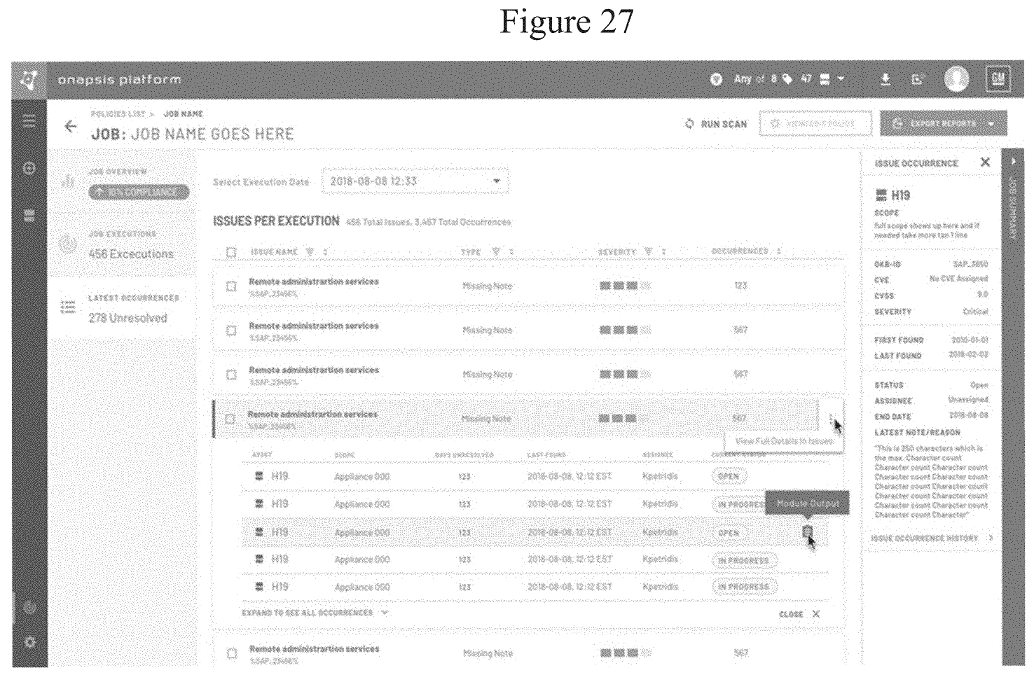

FIG. 27 illustrates issue occurrences for a job. The display may include a list of all issues and occurrences results from a particular job. At the top of the page the date of the results to view can be changed. Clicking on an issue row changes the details panel information to show only information relevant to the row selected and opens the preview of all occurrences. More information on a specific issue can be shown in the issue page upon selection. Selecting multiple rows from the checkboxes opens the batch action bar for managing one or multiple occurrences. Clicking on the Document icon in a row shows this issue occurrence's module output. Clicking on Expand To See All Occurrences button expands all occurrences list for this issue. The tabs on the left can navigate to other pages related to this job.

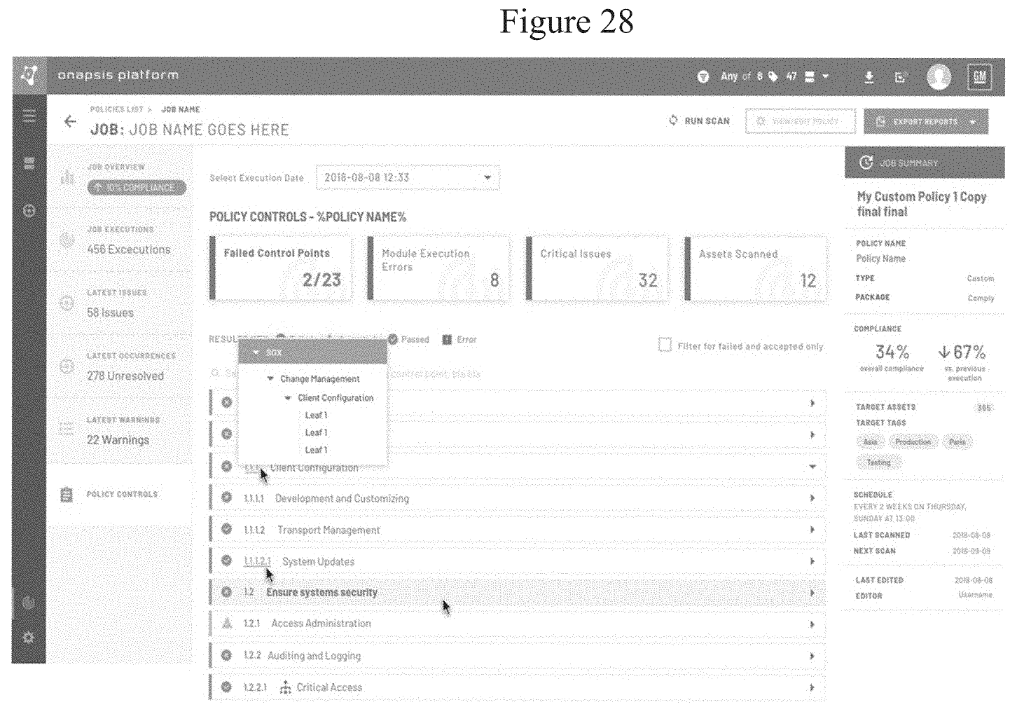

FIG. 28 illustrates policy control of a job. The results of a compliance audit job for each control point and module are shown. In addition, there may be individual results per asset. Selection of specific module can jump to a module's issue occurrences.

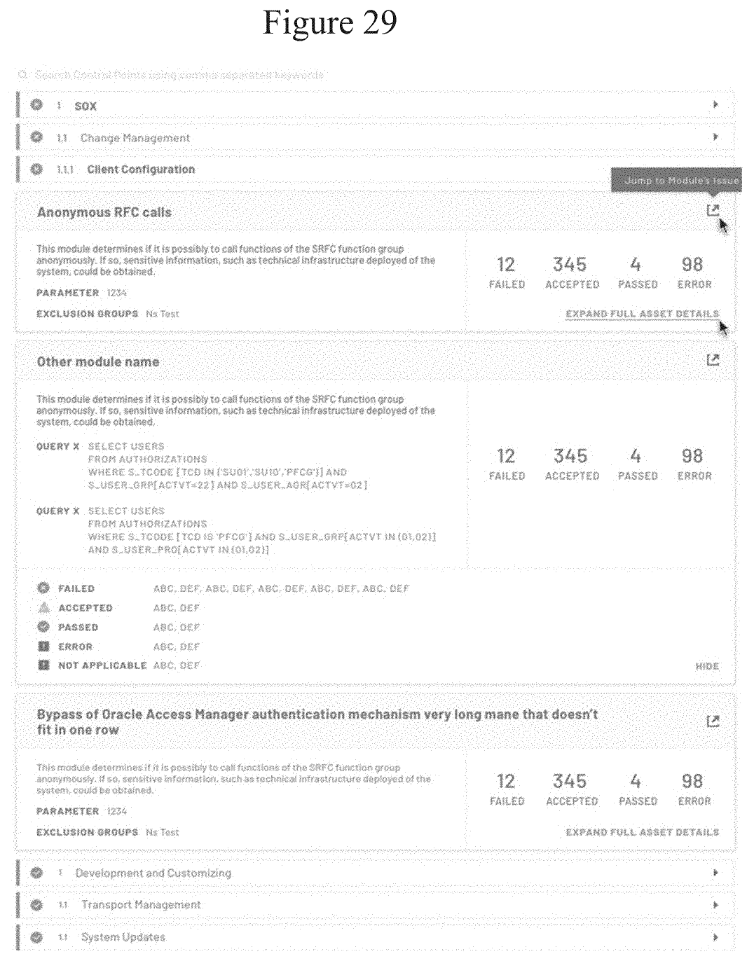

FIG. 29 illustrates a job issue occurrences page with results. This may be the issue occurrences for a specific module, including the failed results (issue occurrences) for that module.

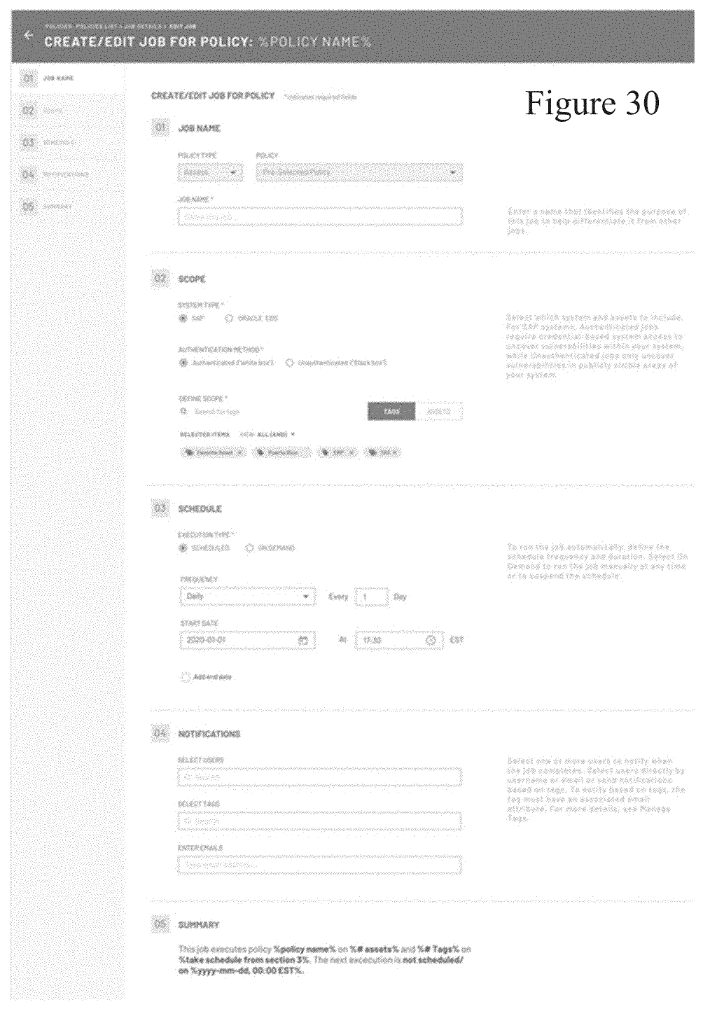

FIG. 30 illustrates job editing. The job editing form can be used to create a new job from a policy or edit a job related to a policy. The tabs on the left can navigate inside the form. It can be saved, canceled, or closed.

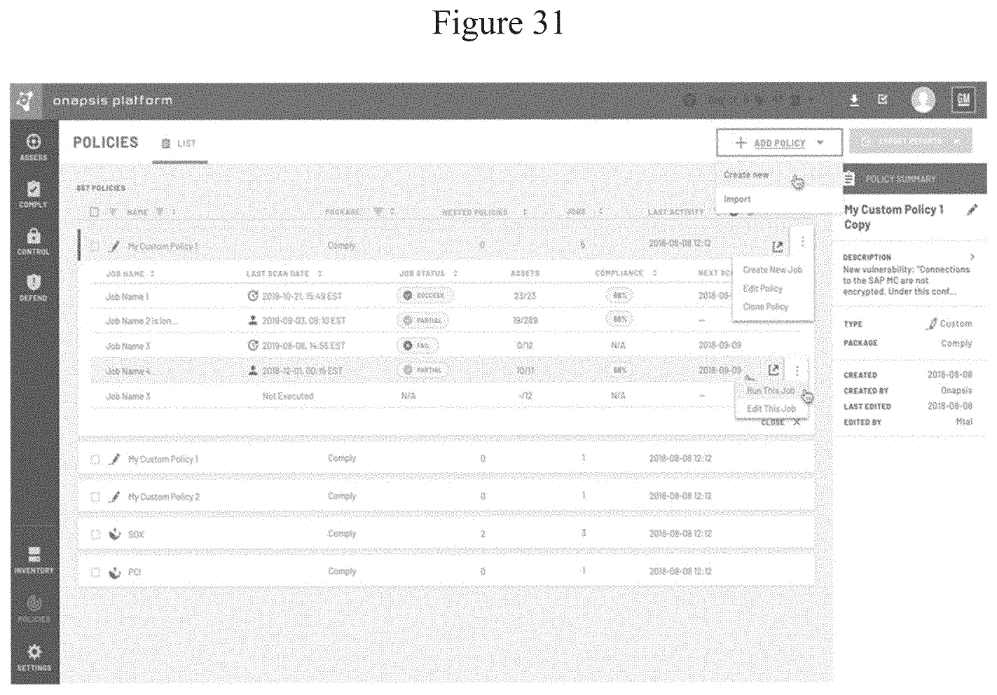

FIG. 31 illustrates policy editing. A new custom policy can be created that includes a number of jobs. The jobs within each policy can be run or edited from this screen. A policy is a way of mapping individual modules/checks to a framework (e.g. COBIT), which is structured using control points in a hierarchical fashion. In a policy, control points can be added, removed and edited.

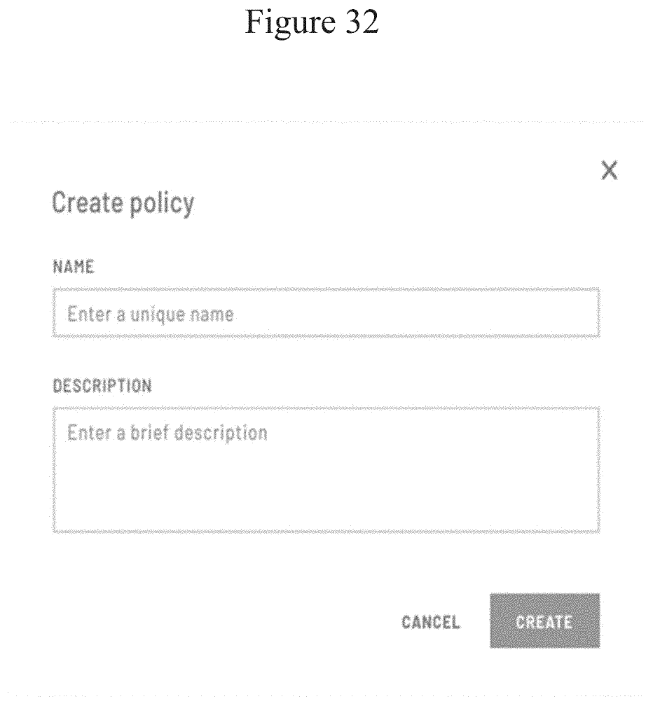

FIG. 32 illustrates creating a new policy. Selecting to create a new policy in FIG. 31 shows this interface for creating a name for a new policy and a description. The policies are listed and displayed in FIG. 31.

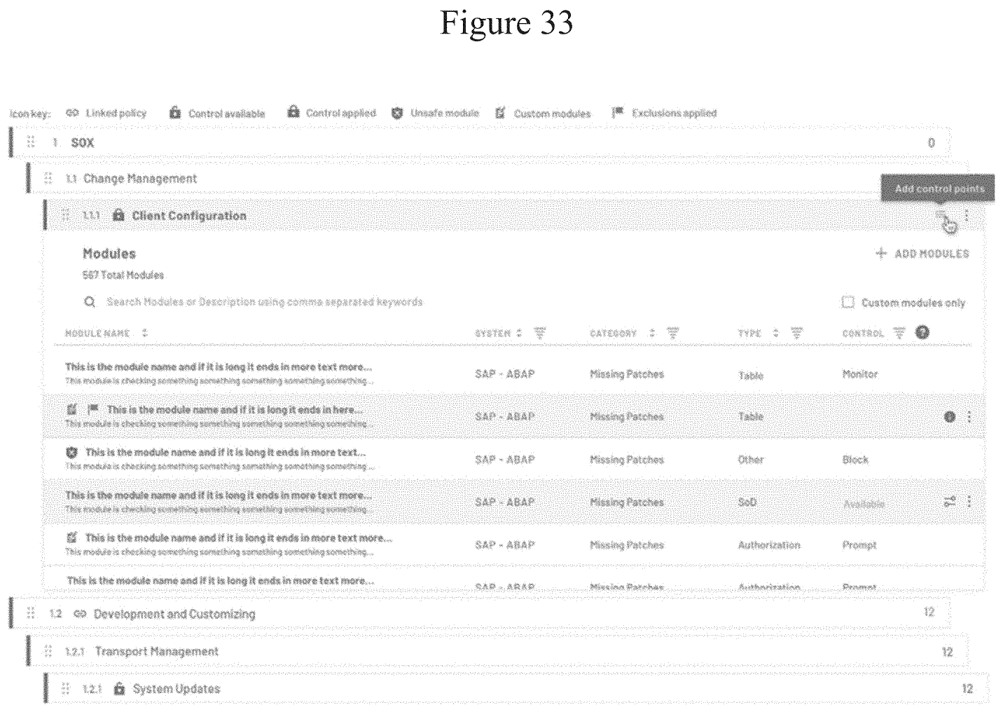

FIG. 33 illustrates editing policy details. The policy may include modules that can be added or edited for controlling. Each module may be specific to a system.

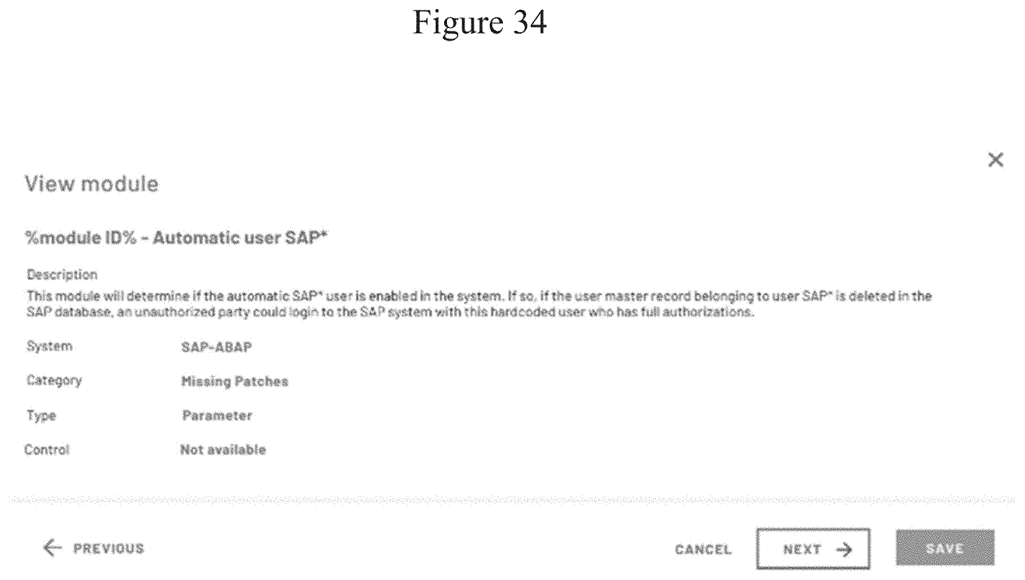

FIG. 34 illustrates viewing a module. Individual modules can be mapped to control points. Clicking on any module views the details for that module.

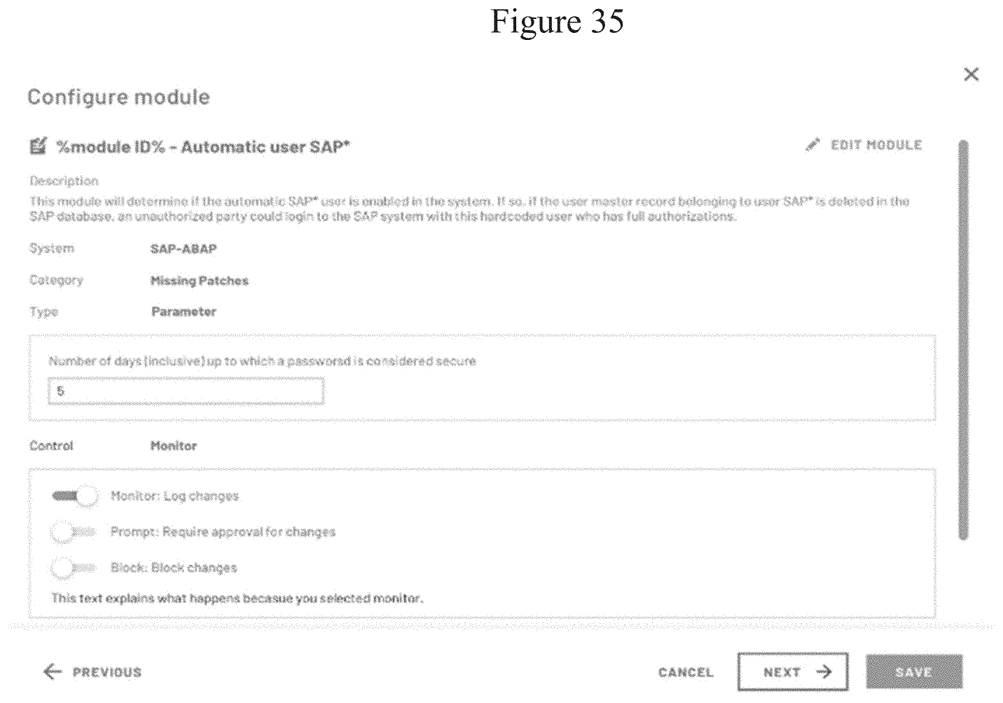

FIG. 35 illustrates configuring a module. The policy of a module can be customized from default values. For example, a password length could be modified from the default value. FIG. 35 illustrates an option for the number of days that password is considered secure.

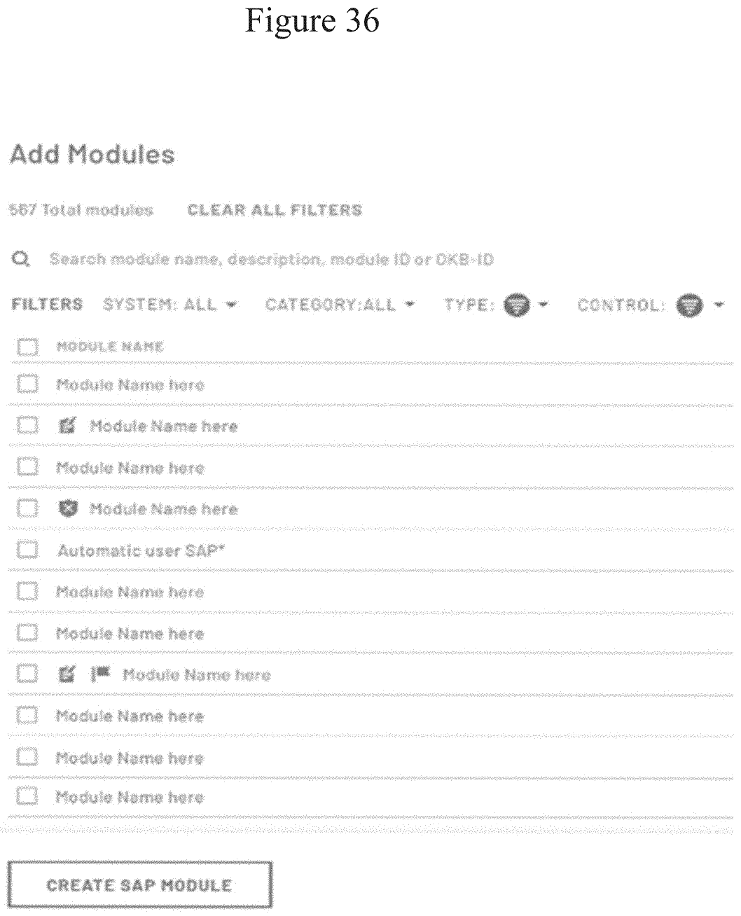

FIG. 36 illustrates adding a module. A module can be added to a control point and the filters allow for sorting the modules by various features.

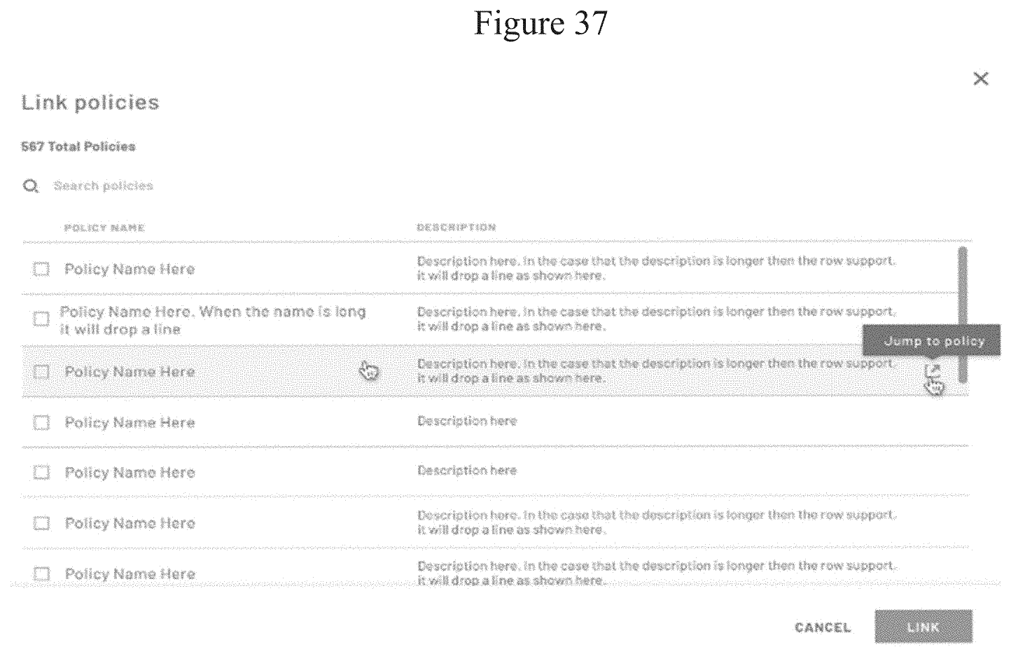

FIG. 37 illustrates linking policies. Each new policy can be linked to an existing policy. The linkage means that any changes to the existing policy will automatically be reflected in the new policy.

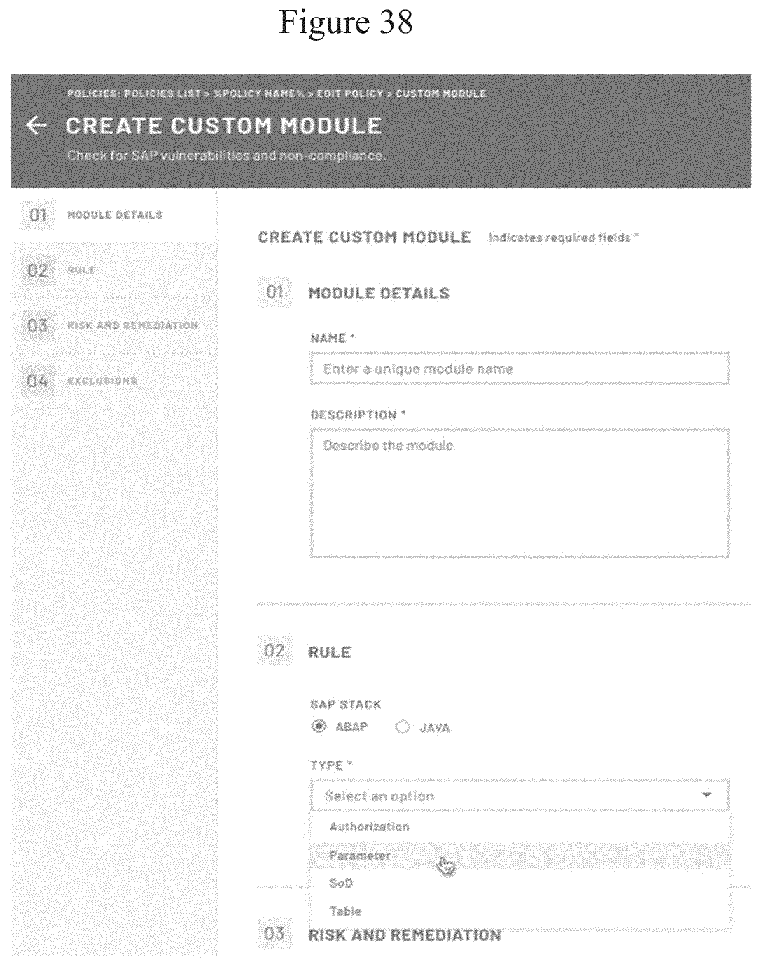

FIG. 38 illustrates creating custom modules. A custom module can be created with module details, rules, risks/remediation, and exclusions. In one example, a characteristic (e.g. system setting or parameter) of the system that is not checked by one of the existing modules can be checked by creating a new custom module for checking that characteristic. The custom module can also set authorizations by reviewing a list of users with combinations of authorizations that violate segregation of duties principles. These authorizations and segregations of duties can be specified through a specific coding language in one embodiment.

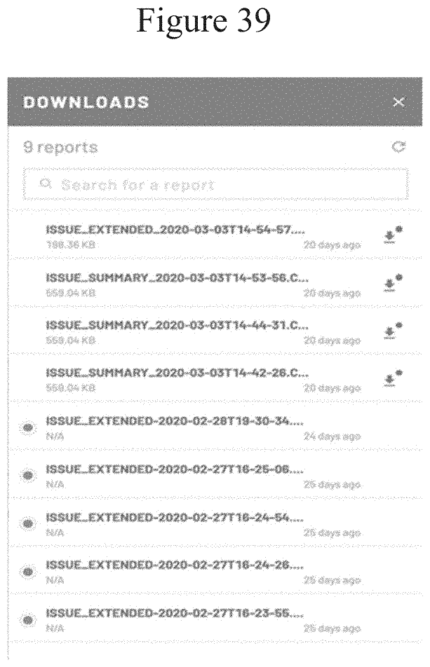

FIG. 39 illustrates a download pane. The download pane may be referred to as a widget. From any page, clicking on the icon for Downloads in the top (right) navigation panel opens the downloads pane. It shows pending generated files that have not been downloaded and recent files downloaded. Clicking outside the download pane closes it.

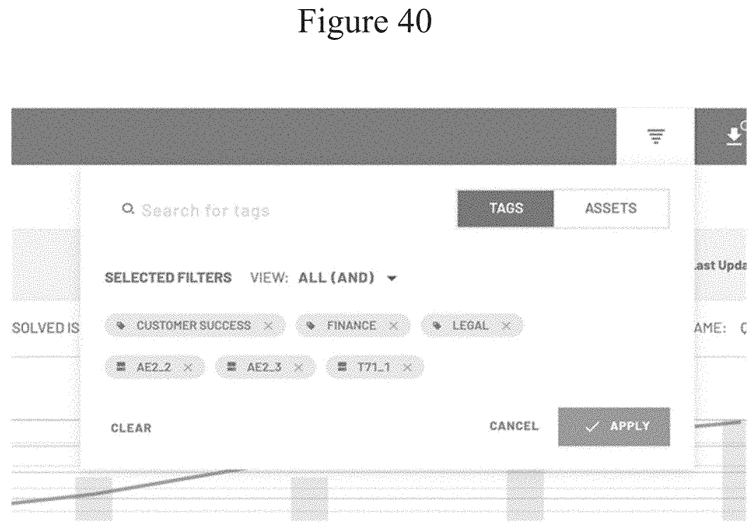

FIG. 40 illustrates global filters. From any page, clicking on the icon for Global Filters in the top (right) navigation panel opens the global filter dropdown. The filters could be applied to all screens until removed.

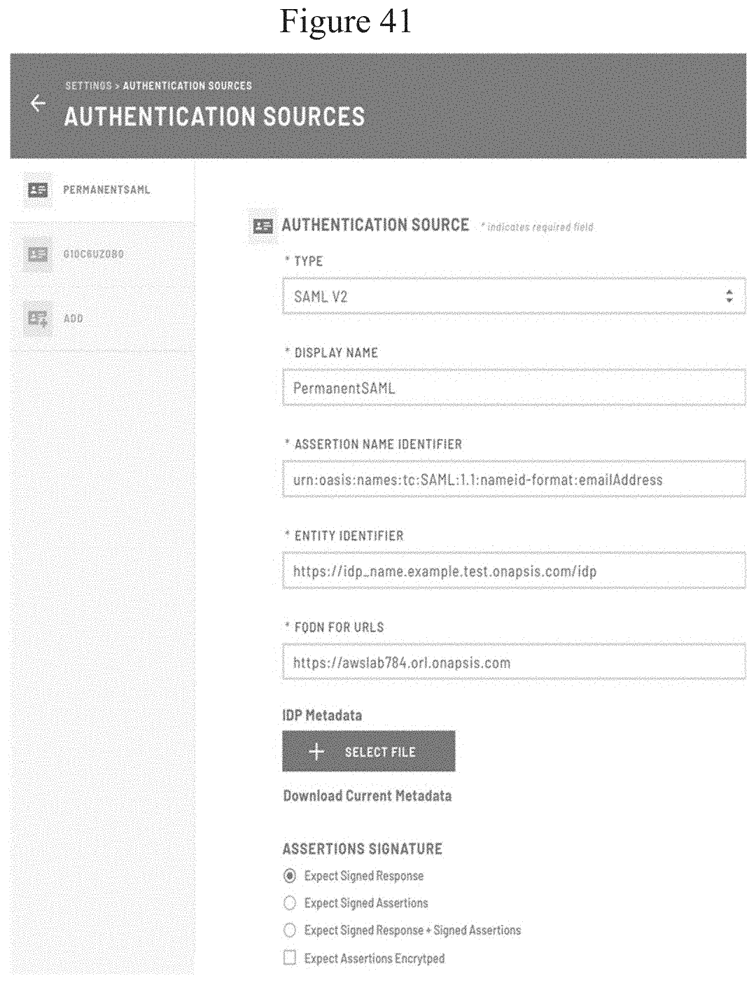

FIG. 41 illustrates authentication sources. The authentication sources page may be accessed from the settings screen. It allows a user select a type of authentication source and add it to a list of sources. Upon making a selection (e.g. SAML V2), the appropriate options will appear below. The user can type in Display Name, the Assertion Name Identifier, the Entity Identifier, the FQDN for URLs (or IP address) of the Web UI. The user can also download the current metadata, select the IDP Metadata, and select an Assertions Signature. Upon entering those details, the user can click Save (not shown) to save this authentication source or delete this source.

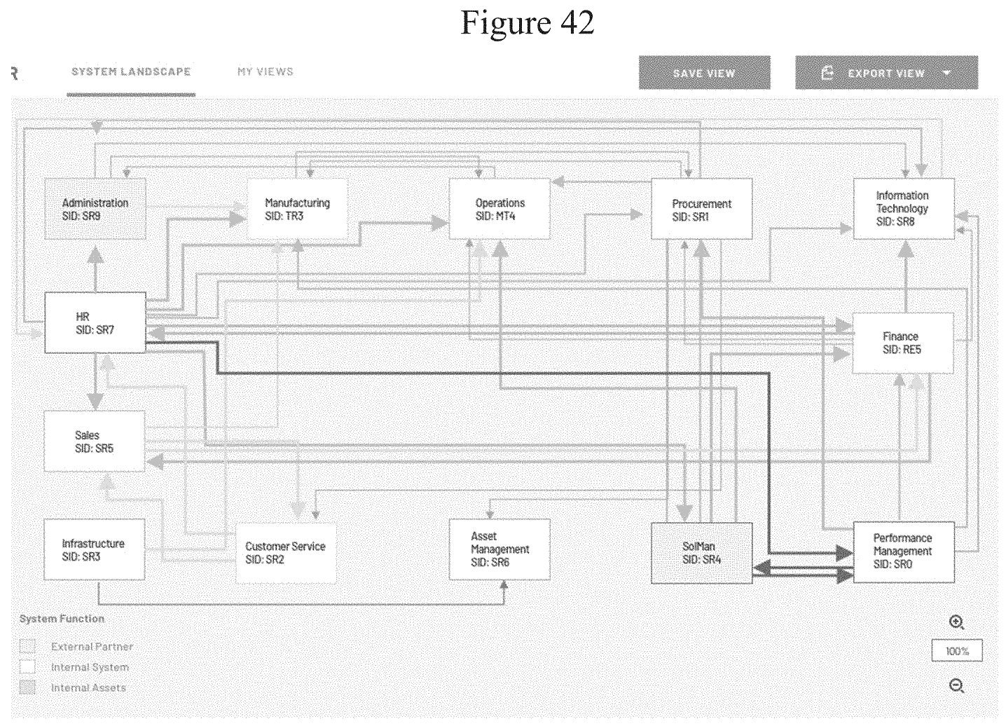

FIG. 42 illustrates a topology explorer system landscape map. The system landscape may be part of an integrated platform that displays a plurality of platforms or systems and the connections between those displays. The connections may be communication paths and are illustrated for each system, including internal systems, external systems, and internal assets. The visual display of the system/platform arrangement and corresponding connections can be used for management of risk and may be part of any of the assess, comply, control and defend elements discussed above.

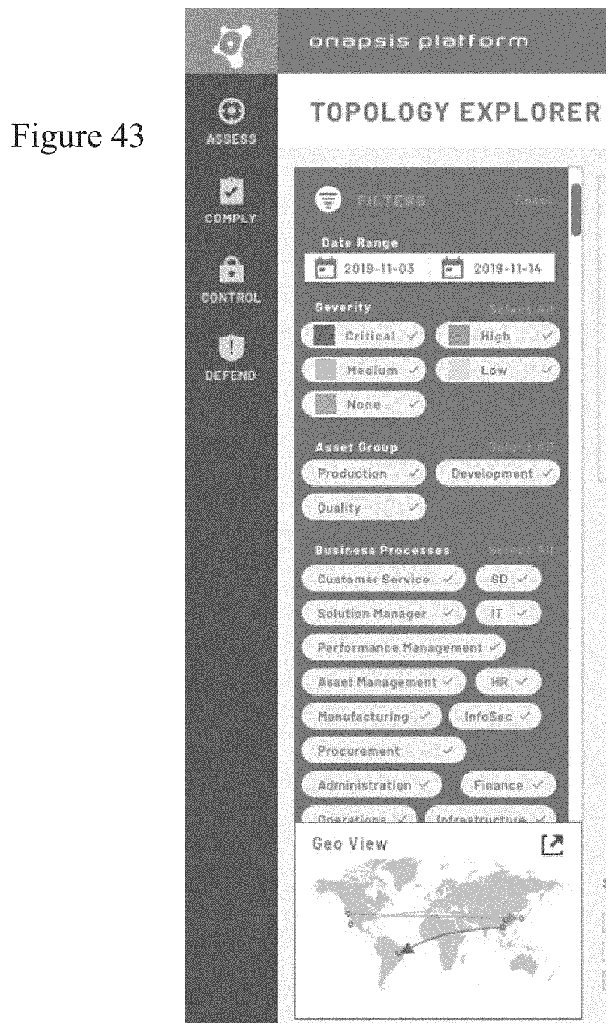

FIG. 43 illustrates a sidebar display for the topology explorer system landscape map. The sidebar may be displayed with the system landscape map shown in FIG. 42. The sidebar allows for a display of platforms/system by date, severity (of potential threats), asset group, and/or business processes. The arrangement of the platforms/systems may be by additional filters not shown in FIG. 43.

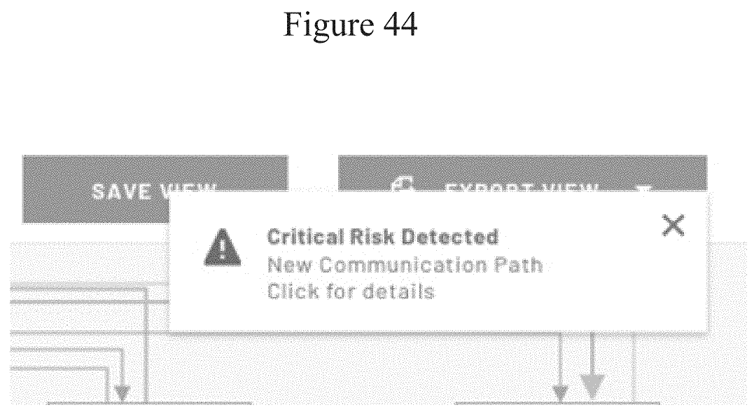

FIG. 44 illustrates a notification for the topology explorer system landscape map. In particular, the system landscape map in FIG. 42 may display the notification upon detection of a critical risk for a new communication path.

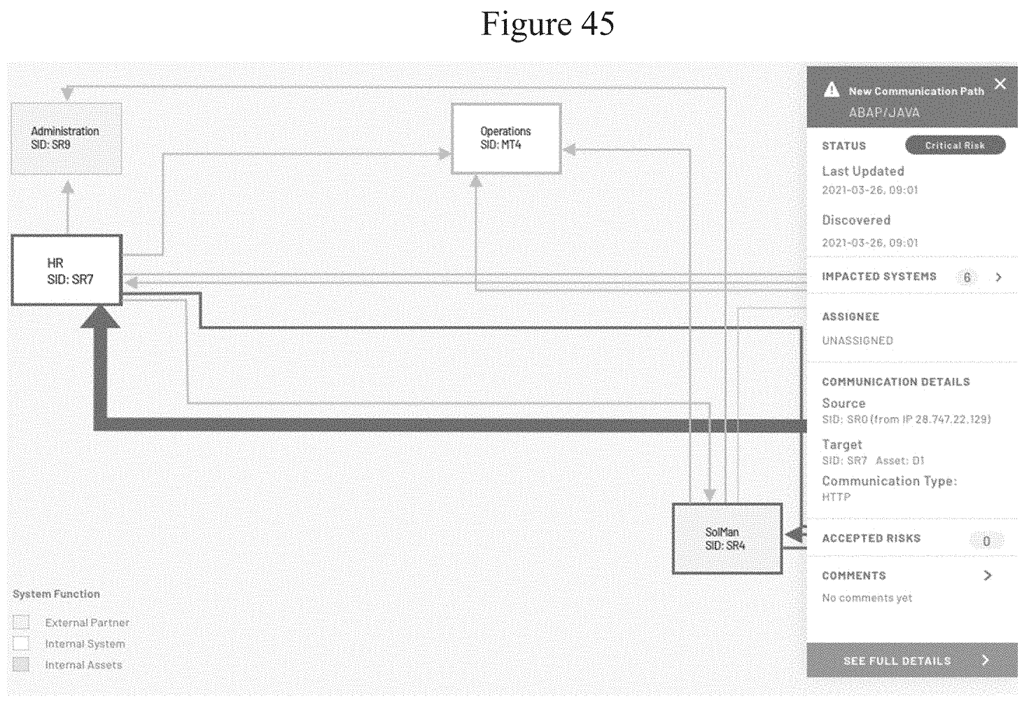

FIG. 45 illustrates a redirection in a topology explorer system landscape map. The system landscape map showing the communications between systems/platforms may illustrate a critical path where there may be a security threat. In this example, the security threat shows a new communication path. That path can impact multiple systems (which are shown), so the system landscape map allows the user to evaluate problems that the new communication (i.e. critical path) may cause. This display is only for those platforms/systems that are impacted by that critical path.

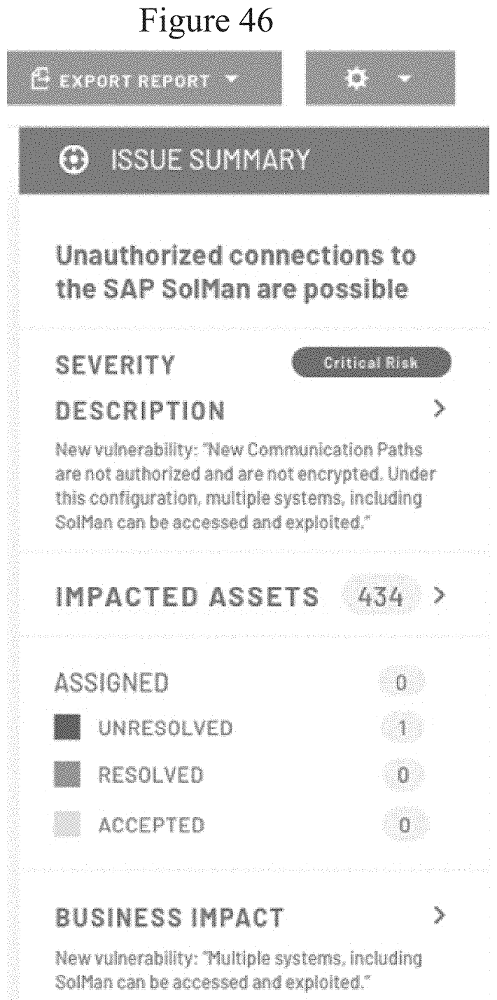

FIG. 46 illustrates an issue summary for a topology explorer system landscape map. The issue summary may be a part of the system landscape map shown above. The issue summary provides details on the potential security risk. In this example, there is a critical risk that includes unauthorized connections to a particular system/platform. The number of impacted assets are 434. The system landscape map identifies the impacted assets so that they can be checked to remove the potential security risk.

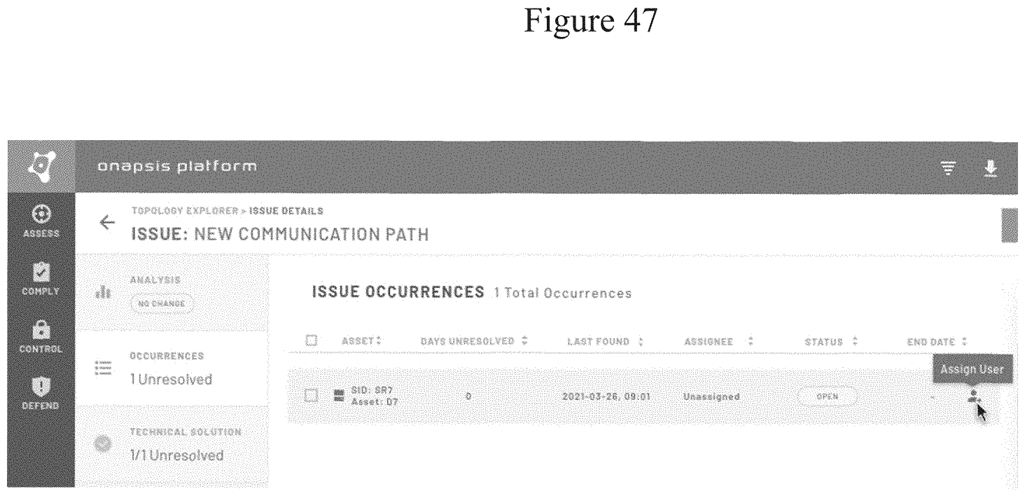

FIG. 47 illustrates issue occurrences in a topology explorer system landscape map. The issue occurrence shown is a new communication path. That issue occurrence is listed with its asset name, days unresolved, last found time, assignee, status and end date. A user may be assigned to handle the issue as shown by the Assign User button.

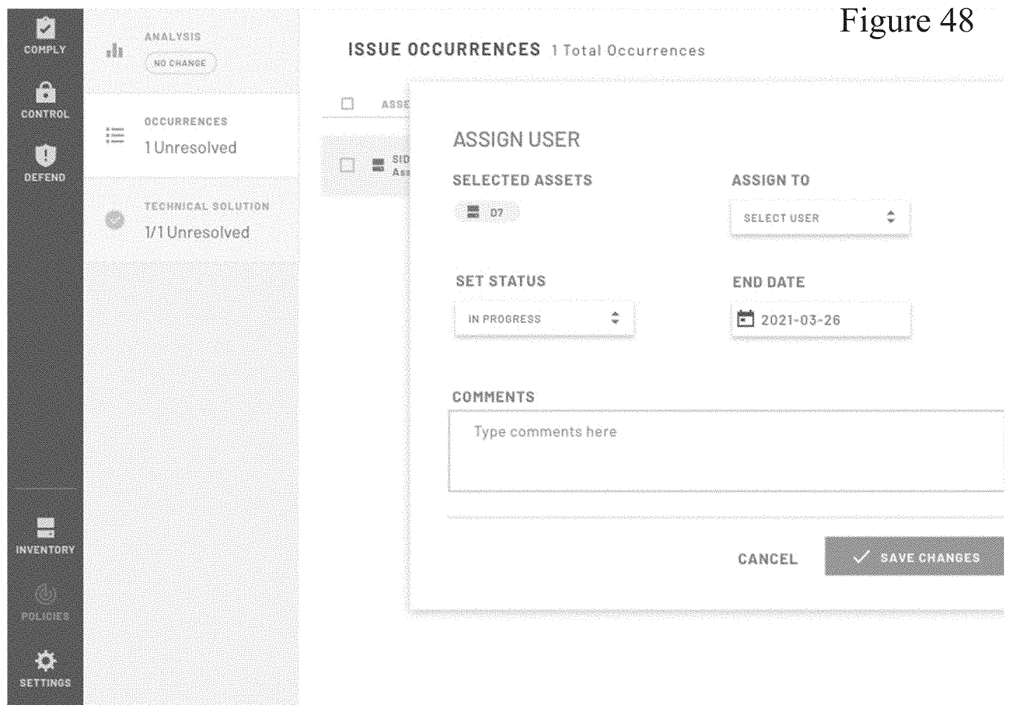

FIG. 48 illustrates a user list for a topology explorer system landscape map. Selecting the assign user button can provide a screen for selecting a user to work on the issue. As part of the user assignment, the assets are selected along with an end date.

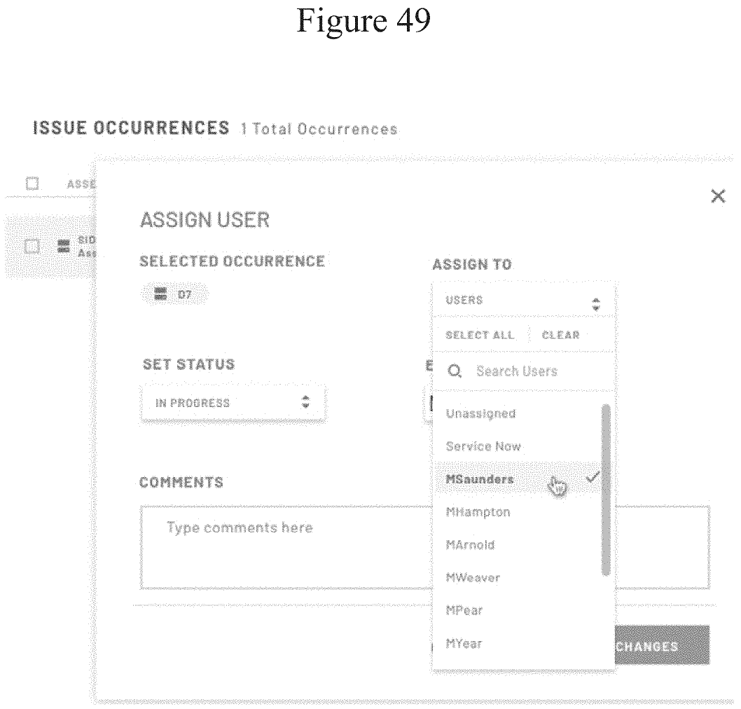

FIG. 49 illustrates assigning a user for a topology explorer system landscape map. The user list may be displayed as a drop down which allows for easy selection of a user to handle the issue.

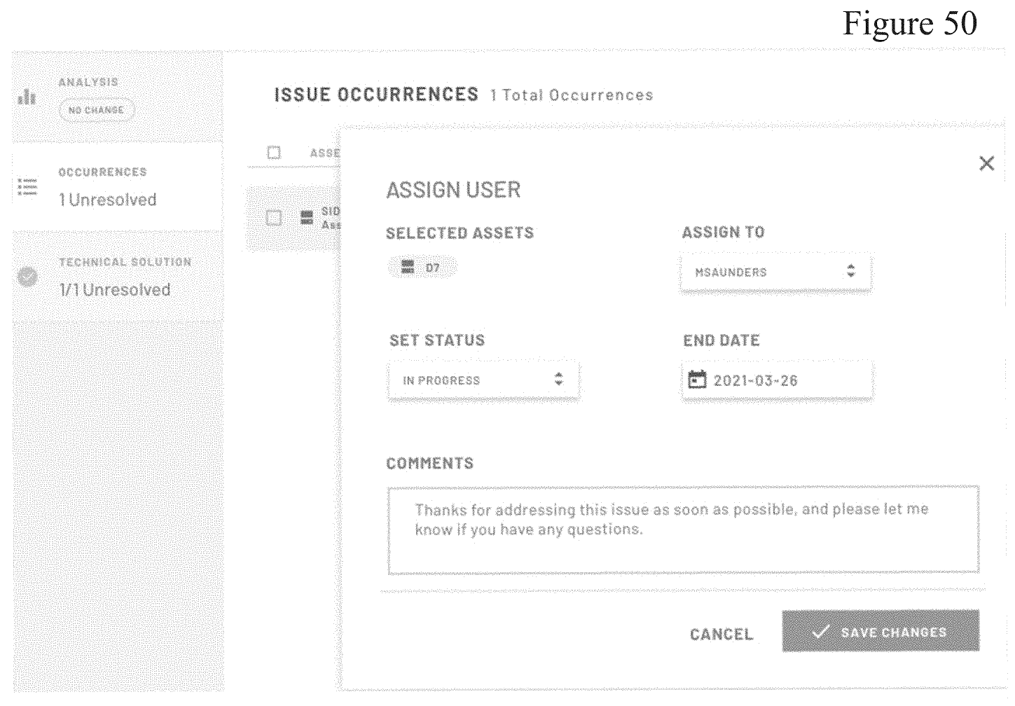

FIG. 50 illustrates a commenting with an assigned user for a topology explorer system landscape map. As part of the user assignment process, a comment can be added to the issue. The comment can provide further information or details about the issue and/or its timeframe for being solved.

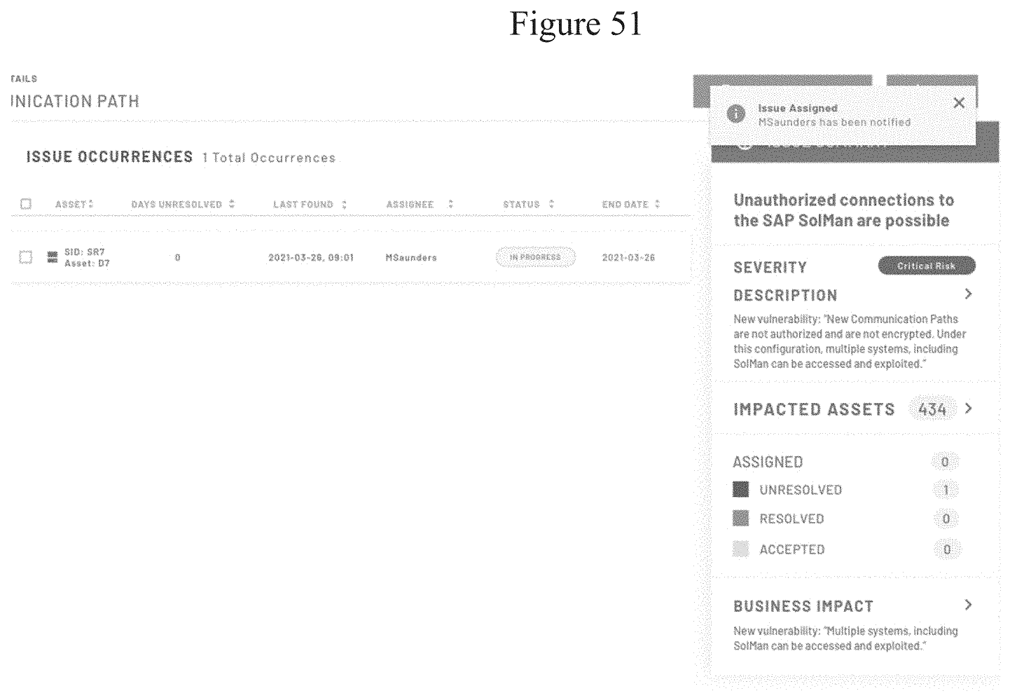

FIG. 51 illustrates a confirmation for issue assignment in a topology explorer system landscape map. After the issue has been assigned, the issue occurrence screen (compare FIG. 47) shows the assigned user and provides an updated status.

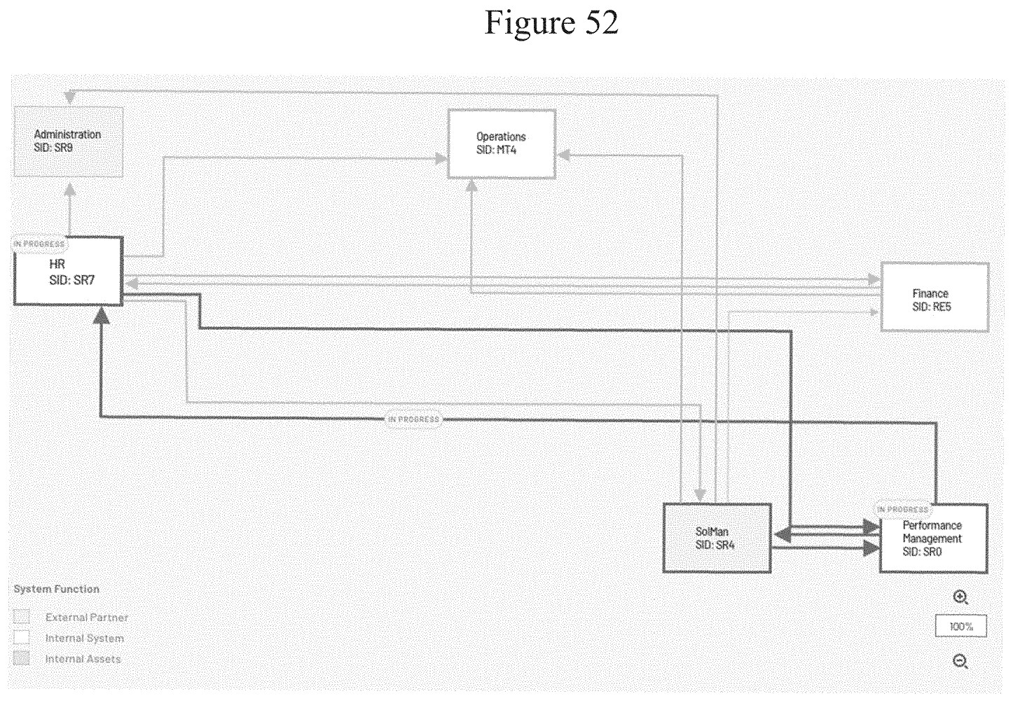

FIG. 52 illustrates a topology explorer system landscape map in progress. Since the issue is assigned, each of the systems/platforms that are impacted by the issue are shown as highlighted in FIG. 52 and listed as in progress. The issue is being addressed and the system landscape map provides a visual of the items (systems/platforms or communication paths) that are impacted by the issue.

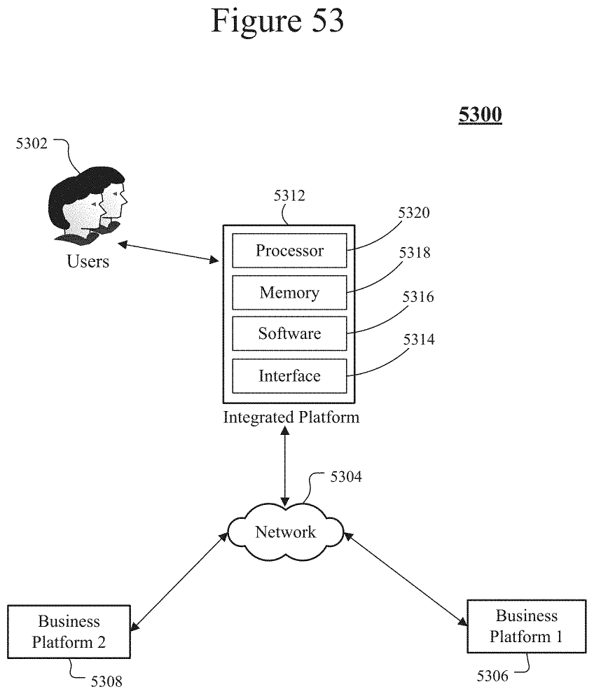

FIG. 53 illustrates a block diagram of an example network system 5300. The system 5300 may be a business application. In some embodiments, the business application is a software application and may include at least one of Customer Relationship Management (CRM), Supplier Relationship Management (SRM), Supply Chain Management (SCM), Product Life-cycle Management (PLM), Human Capital Management (HCM), Integration Platforms, Business Warehouse (BW), Business Intelligence (BI), or enterprise resource planning (ERP).

The system 5300 may include functionality for integrating multiple platforms, such as business platform 1 5306 and business platform 2 5308 together. The platforms may be different functionality that is combined into an integrated platform 5312. The platforms may include functionality for analyzing the business applications discussed above.

The network system 5300 may include a network 5304 that interconnects any of the components. For example, the platforms 5306, 5308 may be connected to the integrated platform 5312 over the network 5304. The network 5304 may be an internal network, an external network, or a combination. Although not shown the users 5302 may interact with the integrated platform 5312 over a network, such as the network 5304. Likewise, the users 5302 may interact with the business platforms 5306, 5308 over a network, such as the network 5304, and that interaction may be through the integrated platform 5312.

The integrated platform 5312 may be a computing device operated by one or more users 5302 for integrated functions, such as the business platforms. In other embodiments, there may be more business platforms that are integrated and two are shown as merely one example.

In one embodiment, the integrated platform 5312 may be software that runs on a computing device as shown in FIG. 53. The integrated platform 5312 provides an interface for integrated business platforms. The integrated platform 5312 may include a processor 5320, a memory 5318, software 5316 and a user interface 5314. In alternative embodiments, the integrated platform 5312 may be multiple devices to provide different functions and it may or may not include all of the user interface 5314, the software 5316, the memory 5318, and/or the processor 5320.

The user interface 5314 may be a user input device or a display. The user interface 5314 may include a keyboard, keypad or a cursor control device, such as a mouse, or a joystick, touch screen display, remote control or any other device operative to allow a user or administrator to interact with the integrated platform 5312. The user interface 5314 may communicate with any of the systems in the network 5304, including the integrated platform 5312, the source 5306, and/or the destination 5308. The user interface 5314 may include a user interface configured to allow a user and/or an administrator to interact with any of the components of the integrated platform 5312 for providing access and functionality for integrated business platforms. The user interface 5314 may include a display coupled with the processor 5320 and configured to display an output from the processor 5320. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 5320, or as an interface with the software 5316 for providing data.

The processor 5320 in the integrated platform 5312 may include a central processing unit (CPU), a graphics processing unit (GPU), a digital signal processor (DSP) or other type of processing device. The processor 5320 may be a component in any one of a variety of systems. For example, the processor 5320 may be part of a standard personal computer or a workstation. The processor 5320 may be one or more general processors, digital signal processors, application specific integrated circuits, field programmable gate arrays, servers, networks, digital circuits, analog circuits, combinations thereof, or other now known or later developed devices for analyzing and processing data. The processor 5320 may operate in conjunction with a software program (i.e. software 5316), such as code generated manually (i.e., programmed). The software 5316 may include a process for integrating business platforms.

The processor 5320 may be coupled with the memory 5318, or the memory 5318 may be a separate component. The software 5316 may be stored in the memory 5318. The memory 5318 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 5318 may include a random access memory for the processor 5320. Alternatively, the memory 5318 may be separate from the processor 5320, such as a cache memory of a processor, the system memory, or other memory. The memory 5318 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 5318 is operable to store instructions executable by the processor 5320.

The functions, acts or tasks illustrated in the figures or described herein may be performed by the programmed processor executing the instructions stored in the software 5316 or the memory 5318. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 5320 is configured to execute the software 5316.

The present disclosure contemplates a computer-readable medium that includes instructions or receives and executes instructions responsive to a propagated signal, so that a device connected to a network can communicate voice, video, audio, images or any other data over a network. The user interface 5314 may be used to provide the instructions over the network via a communication port. The communication port may be created in software or may be a physical connection in hardware. The communication port may be configured to connect with a network, external media, display, or any other components in system 5300, or combinations thereof. The connection with the network may be a physical connection, such as a wired Ethernet connection or may be established wirelessly as discussed below. Likewise, the connections with other components of the system 5300 may be physical connections or may be established wirelessly.

Any of the components in the system 5300 may be coupled with one another through a (computer) network, including but not limited to the network 5304. In some business applications (e.g. ERP systems), the network 5304 may be a local are network (“LAN”), or may be a public network such as the Internet. Accordingly, any of the components in the system 5300 may include communication ports configured to connect with a network. The network or networks that may connect any of the components in the system 5300 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The meaning of specific details should be construed as examples within the embodiments and are not exhaustive or limiting the invention to the precise forms disclosed within the examples. One skilled in the relevant art will recognize that the invention can also be practiced without one or more of the specific details or with other methods, implementations, modules, entities, datasets, etc. In other instances, well-known structures, computer-related functions or operations are not shown or described in detail, as they will be understood by those skilled in the art.

The discussion above is intended to provide a brief, general description of a suitable computing environment (which might be of different kind like a client-server architecture or an Internet/browser network) in which the invention may be implemented. The invention will be described in general context of computer-executable instructions, such as software modules, which might be executed in combination with hardware modules, being executed by different computers in the network environment. Generally, program modules or software modules include routines, programs, objects, classes, instances, components, data structures, etc., that perform particular tasks or implement particular abstract data types. Computer-executable instructions, associated data structures and program modules represent examples of the program code means for executing steps of the method described herein. The particular sequence of such executable instructions, method steps or associated data structures only represent examples of corresponding activities for implementing the functions described therein. It is also possible to execute the method iteratively.

Those skilled in the art will appreciate that the invention may be practiced in a network computing environment with many types of computer system configurations, including personal computers (PC), hand-held devices (for example, smartphones), multi-processor systems, microprocessor-based programmable consumer electronics, network PCs, minicomputers, mainframe computers, laptops and the like. Further, the invention may be practiced in distributed computing environments where computer-related tasks are performed by local or remote processing devices that are linked (either by hardwired links, wireless links or by a combination of hardwired or wireless links) through a communications network. In a distributed computing environment, program modules may be located in local or remote devices, memory systems, retrievals or data storages.

Generally, the method according to the invention may be executed on one single computer or on several computers that are linked over a network. The computers may be general purpose computing devices in the form a conventional computer, including a processing unit, a system memory, and a system bus that couples various system components including system memory to the processing unit. The system bus may be any one of several types of bus structures including a memory bus or a memory controller, a peripheral bus and a local bus using any of a variety of bus architectures, possibly such which will be used in clinical/medical system environments. The system memory includes read-only memory (ROM) and random access memories (RAM). A basic input/output system (BIOS), containing the basic routines that have the functionality to transfer information between elements within the computer, such as during start-up, may be stored in one memory. Additionally, the computer may also include hard disc drives and other interfaces for user interaction. The drives and their associated computer-readable media provide non-volatile or volatile storage of computer executable instructions, data structures, program modules and related data items. A user interface may be a keyboard, a pointing device or other input devices (not shown in the figures), such as a microphone, a joystick, a mouse. Additionally, interfaces to other systems might be used. These and other input devices are often connected to the processing unit through a serial port interface coupled to system bus. Other interfaces include a universal serial bus (USB). Moreover, a monitor or another display device is also connected to the computers of the system via an interface, such as video adapter. In addition to the monitor, the computers typically include other peripheral output or input devices (not shown), such as speakers and printers or interfaces for data exchange. Local and remote computer are coupled to each other by logical and physical connections, which may include a server, a router, a network interface, a peer device or other common network nodes. The connections might be local area network connections (LAN) and wide area network connections (WAN) which could be used within intranet or internet. Additionally, a networking environment typically includes a modem, a wireless link or any other means for establishing communications over the network.

Moreover, the network typically comprises means for data retrieval, particularly for accessing data storage means like repositories, etc. Network data exchange may be coupled by means of the use of proxies and other servers.

The example embodiments are to be considered in all respects only as illustrative and not restrictive. The scope of the invention is, therefore, indicated by the appended claims rather than by this description. All changes which come within the meaning and range of equivalency of the claims are to be embraced within their scope.

1. A network system comprising:
a business application;
a plurality of security systems for the business application;
an integrated platform connecting the security systems for the business application; and
a user interface for the integrated platform that provides access and control for each of the security systems as the integrated platform.

2. The network system of claim 1, further comprising:
a topology explorer system landscape map displaying the security systems and communications between the security systems.

3. The network system of claim 2, wherein the topology explorer system landscape map identifies a security issue and identifies which of the security systems and communications are impacted by the security issue.

4. The network system of claim 3, wherein the topology explorer system landscape map displays the identified security systems and the communications impacted by the security issue.

5. The network system of claim 1, wherein each of the security systems comprise different functionality for risk management for the business application.

6. The network system of claim 5, wherein the business application comprises a software application.

7. The network system of claim 6, wherein the software application comprises at least one of Customer Relationship Management (CRM), Supplier Relationship Management (SRM), Supply Chain Management (SCM), Product Life-cycle Management (PLM), Human Capital Management (HCM), Integration Platforms, Business Warehouse (BW), Business Intelligence (BI), or enterprise resource planning (ERP).

8. In a business application, a computer system for integrating platforms for a business application, comprising:
a plurality of security systems for the business application;
an integrated platform connecting the security systems for the business application; and
a user interface for the integrated platform that provides access and control for each of the security systems as the integrated platform, wherein the user interface comprises a topology explorer system landscape map.

9. The computer system of claim 8, wherein the topology explorer system landscape map displays the security systems and communications between the security systems.

10. The computer system of claim 8, wherein the topology explorer system landscape map identifies a security issue and identifies which of the security systems and communications are impacted by the security issue.

11. The computer system of claim 10, wherein the topology explorer system landscape map displays the identified security systems and the communications impacted by the security issue.

12. The computer system of claim 8, wherein each of the security systems comprise different functionality for risk management for the business application.

13. The computer system of claim 12, wherein the business application comprises a software application.

14. The computer system of claim 13, wherein the software application comprises at least one of Customer Relationship Management (CRM), Supplier Relationship Management (SRM), Supply Chain Management (SCM), Product Life-cycle Management (PLM), Human Capital Management (HCM), Integration Platforms, Business Warehouse (BW), Business Intelligence (BI), or enterprise resource planning (ERP).

15. A method for an integration platform comprising:
providing security systems for a business application;
combining the provided security systems into the integration platform;
performing functions from each of the security systems by the integration platform;
providing a user interface for the integration platform for accessing and controlling the performed functions form the integrated platforms; and
displaying a topology explorer system landscape map for the integration platform that displays the security systems and communications between the security systems for the integration platform.

16. The method of claim 16, further comprising:
identifying a security issue; and
identifying which of the security systems and communications are impacted by the security issue.

17. The method of claim 16, further comprising:
displaying on the topology explorer system landscape map the identified security systems and the communications impacted by the security issue.

18. The method of claim 16, wherein the business application comprises a software application.

19. The method of claim 18, wherein the software application comprises at least one of Customer Relationship Management (CRM), Supplier Relationship Management (SRM), Supply Chain Management (SCM), Product Life-cycle Management (PLM), Human Capital Management (HCM), Integration Platforms, Business Warehouse (BW), Business Intelligence (BI), or enterprise resource planning (ERP).
